(19) United States
(12) Patent Application Publication
(10) Pub. No.: US 2020/0403674 A1
(43) Pub. Date: Dec. 24, 2020

(54) EFFICIENT CALIBRATION FOR IMPLICIT FEEDBACK

(71) Applicants: Qinghua Li, San Ramon, CA (US); Ziv Avital, Kadima (IL); Xiaogang Chen, Portland, OR (US); Assaf Gurevitz, Ramat Hasharon (IL); Po-Kai Huang, San Jose, CA (US); Feng Jiang, Santa Clara, CA (US); Robert Stacey, Portland, OR (US)

(72) Inventors: Qinghua Li, San Ramon, CA (US); Ziv Avital, Kadima (IL); Xiaogang Chen, Portland, OR (US); Assaf Gurevitz, Ramat Hasharon (IL); Po-Kai Huang, San Jose, CA (US); Feng Jiang, Santa Clara, CA (US); Robert Stacey, Portland, OR (US)

(21) Appl. No.: 17/013,362

(22) Filed: Sep. 4, 2020

Related U.S. Application Data
(60) Provisional application No. 62/895,708, filed on Sep. 4, 2019.
(60) Provisional application No. 62/895,710, filed on Sep. 4, 2019.
(60) Provisional application No. 62/895,781, filed on Sep. 4, 2019.

(51) Int. Cl. H04B 7/06; H04B 17/14; H04L 12/26; H04W 24/02; H04L 25/02

(52) U.S. Cl. CPC H04B 7/0617; H04B 17/14; H04L 25/0204; H04W 24/02; H04L 43/12

(57) ABSTRACT

This disclosure describes systems, methods, and devices related to efficient calibration for implicit feedback. A device may cause to send a first sounding frame to a first station device, wherein the first sounding frame is used for a calibration of a plurality of (TX) antennas and a plurality of (RX) antennas. The device may identify one or more quantization indices received from the first station device. The device may reconstruct the feedback vector using the one or more quantization indices. The device may identify a second sounding frame from the first station device. The device may determine second channel estimates based on the RX antenna at the first station device and the plurality of TX antennas at the device. The device may compare the reconstructed feedback vector with the second channel estimates. The device may determine a compensation scalar based on the comparison.

### CROSS-REFERENCE TO RELATED APPLICATION(S)

This application claims the benefit of U.S. Provisional Application No. 62/895,708, filed Sep. 4, 2019, U.S. Provisional Application No. 62/895,710, filed Sep. 4, 2019, and U.S. Provisional Application No. 62/895,781, filed Sep. 4, 2019, all disclosures of which are incorporated herein by reference as if set forth in full.

### TECHNICAL FIELD

This disclosure generally relates to systems and methods for wireless communications and, more particularly, to efficient calibration for implicit feedback.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for efficient calibration for implicit feedback, in accordance with one or more example embodiments of the present disclosure.

FIG. 2 depicts an illustrative schematic diagram for efficient calibration for implicit feedback, in accordance with one or more example embodiments of the present disclosure.

FIG. 3 depicts an illustrative schematic diagram for calibration exchange in single user mode, in accordance with one or more example embodiments of the present disclosure.

FIGS. 4-5 depict illustrative schematic diagrams for packet error ratio (PER) plots, in accordance with one or more example embodiments of the present disclosure.

FIG. 6 depicts an illustrative schematic diagram for physical layer (PHY) protocol data unit (PPDU) format of calibration feedback, in accordance with one or more example embodiments of the present disclosure.

FIG. 7 depicts an illustrative schematic diagram for transceiver calibration for implicit feedback, in accordance with one or more example embodiments of the present disclosure.

FIG. 8 depicts an illustrative schematic diagram for transceiver calibration for implicit feedback, in accordance with one or more example embodiments of the present disclosure.

FIGS. 9A-9B depict illustrative schematic diagrams for transceiver calibration, in accordance with one or more example embodiments of the present disclosure.

FIGS. 10A-10C depict illustrative schematic diagrams for transceiver calibration, in accordance with one or more example embodiments of the present disclosure.

FIG. 11 depicts an illustrative schematic diagram for transceiver calibration, in accordance with one or more example embodiments of the present disclosure.

FIG. 12 depicts an illustrative schematic diagram for transceiver calibration, in accordance with one or more example embodiments of the present disclosure.

FIG. 13 illustrates a flow diagram of illustrative process for an illustrative efficient calibration for implicit feedback system, in accordance with one or more example embodiments of the present disclosure.

FIG. 14 illustrates a functional diagram of an exemplary communication station that may be suitable for use as a user device, in accordance with one or more example embodiments of the present disclosure.

FIG. 15 illustrates a block diagram of an example machine upon which any of one or more techniques (e.g., methods) may be performed, in accordance with one or more example embodiments of the present disclosure.

FIG. 16 is a block diagram of a radio architecture in accordance with some examples.

FIG. 17 illustrates an example front-end module circuitry for use in the radio architecture of FIG. 16, in accordance with one or more example embodiments of the present disclosure.

FIG. 18 illustrates an example radio IC circuitry for use in the radio architecture of FIG. 16, in accordance with one or more example embodiments of the present disclosure.

FIG. 19 illustrates an example baseband processing circuitry for use in the radio architecture of FIG. 16, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in or substituted for, those of other embodiments. Embodiments set forth in the claims encompass all available equivalents of those claims.

As the number of antennas increases e.g., 16 antennas for 802.11be, the feedback overhead for beamforming becomes burdensome. Implicit feedback is a way to solve the problem. However, it is challenging for self-calibration to achieve high accuracy required by downlink multi-user (MU) multiple-input multiple-output (MIMO).

Implicit feedback was adopted by 802.11n to reduce the feedback overhead. However, it requires calibrating the transmit (Tx) and receive (Rx) chains (also referred to as radiofrequency (RF) chains) associated with the plurality of antennas of the transmitter device and the receiver device.

The Tx chain of an antenna may comprise a digital-to-analog converter (DAC), which creates an analog signal. This signal may be filtered and upconverted. The signal may be amplified and duplexed with a stream from a different band (in case of dual-band device). In the receiving chain, the signal may be amplified using a low noise amplifier, down-converted, then gain may be normalized and converted into digital samples.

The calibration protocol defined in 802.11n requires quantizing the channel matrixes or vectors individually and sending them back. Since the channel responses of the Tx and Rx chains vary with the operating point e.g., the amplification gain, the calibration may need to be done frequently and thus the calibration overhead becomes significant. Besides, since the channel matrix feedback is different from the conventional, explicit feedback for beamforming matrixes or vectors, the channel matrix feedback and thus the implicit feedback has not been implemented by major chip vendors yet.

Example embodiments of the present disclosure relate to systems, methods, and devices for efficient calibration for implicit feedback.

In order to prepare communication channels using a plurality of antennas between devices, antenna calibration needs to be used. Antenna calibration may be used to remove distortions between the antennas on the communication channels. Further calibration may be used in order to establish channel reciprocity.

In one or more embodiments, a beamforming feedback vector may be used to help a transmitting device performing calibration on its side (e.g., an AP or an STA) to perform calibration. The beamforming feedback vector may include a quantized feedback vector. This quantized feedback vector may be broken down into angles and then send those to the device. Implicit feedback requires Tx/Rx chain calibration at the transmitter. The feedback vector is used for calibration purposes though it can be used for beamforming at the same time as well. Namely, the calibration feedback may be merged into the beamforming feedback. For example, an STA may quantize a feedback vector and may send a resulting one or more quantization indices. The STA may send these quantized indices of the feedback vector to an AP. The one or more quantization indices may be associated with a quantization of a feedback vector, where the quantization of the feedback vector is performed by jointly quantizing first channel estimates from an RX antenna at the STA and each of the plurality of TX antennas at the AP. Joint quantization differentiates from legacy protocols' (e.g., from 802.11n (“11n”)) channel state information (CSI) feedback for radiofrequency (RF) chain calibration of the implicit beamforming feedback. For example, 11n CSI feedback uses scalar quantization instead of vector quantization. The scalar quantization quantizes each element of the feedback vector individually instead of jointly. The separate quantization in 11n has two downsides. First, it is not implemented by the industry. Second, it results in a larger feedback overhead. The joint quantization method results in a smaller quantization overhead and is used by the beamforming feedback in 802.11n, 802.11ac, or 802.11ax.

In one or more embodiments, a transmitting device that may be considered a beamformer (e.g., AP) may need channel estimates of both forward and backward directions for estimating a compensation factor used to calibrate the antennas. The receiving devices (e.g., beamformee) may feed back the channel estimates calculated from one of its receive (RX) antennas. For example, for N×M multiple-input multiple-output (MIMO) channel, the beamformee selects one antenna out of M receive (RX) antennas, downgrades the channel to N×1 MISO, and feeds back the beamforming vector of the MISO as the channel vector. The Beamformer uses the fed back beamforming vector as the channel vector in estimating the compensation factors. The channel estimate may be the aggregation of three components: 1) the channel response between Rx and Tx antennas, 2) Tx chain responses, and 3) Rx chain response.

In one or more embodiments, in traditional beamforming feedback, singular value decomposition (SVD) is used in order to decompose a matrix into three matrices. In one or more embodiments, efficient calibration for implicit feedback may omit using SVD during the quantization of the channel responses associated with receiving a sounding frame from a device (e.g., an AP). SVD may refer to a matrix factorization method. SVD may include decomposing a matrix A into a product of three matrices UAV^{T}, where U and V are matrices of singular vectors and A is a diagonal matrix of singular values.

The explicit beamforming feedback for the transmit chain calibration may be used by skipping the SVD step in calculating beamforming feedback. For example, for a MIMO channel with 4 transmit and 2 receive antennas, the channel matrix H is 2 by 4 (2×4). The explicit beamforming feedback calculates the SVD of H and gets a 4×2 beamforming matrix V, which is a unitary matrix. The V matrix is deposed into Givens angles by Givens rotation operations. The Givens angles are then quantized and fed back. In this proposed method, the SVD step is skipped and the H is treated as two 1×4 channels instead of one 2×4 channel. The beamforming vector(s) of one (or two) 1×4 channel(s) is fed back reusing the conventional method (e.g., Givens angles). The one change needed is that the 802.11 standard should allow the beamformer to ask for the beamforming vector for a specific beamformee's receive antenna.

The proposed scheme is fully compatible with the existing implementation. In addition, it is even simpler than the existing by not performing the SVD.

In one or more embodiments, a transceiver calibration for an implicit feedback system may facilitate solutions for multiple aspects of transceiver calibration. First, the number of spatial streams in the long training field (LTF) portion is allowed to be different from the number of spatial streams in the data portion so that all the antennas can be excited while the data can be yet reliably received. Second, the feedback duration can be reduced by splitting the calibration load in frequency or data streams such that stations can send calibration feedback simultaneously. Third, the repetition of the LTF symbols is allowed so that the reception quality can be improved for reducing the calibration error. Fourth, the frequency sampling rate for calibration feedback can be lower than the beamforming feedback for reducing overhead. Finally, the antenna mappings between the channel sounding and the calibration feedback needs to be consistent so that the channel estimates received from the sounding and feedback match.

The proposed techniques can improve the efficiency of implicit feedback so that downlink multiuser multiple-input multiple-output (MIMO) can penetrate the market.

Example embodiments of the present disclosure relate to systems, methods, and devices for frame exchange and indications for transceiver calibration.

In one or more embodiments, a transceiver calibration system may describe the MAC frame exchange sequence and required indications, which is compatible with the existing beamforming feedback sequence.

In one embodiment, a transceiver calibration system may reuse the frame exchange sequences for the popular beamforming feedback. Only some indication needs to be added in the null data packet announcement (NDPA) or trigger or feedback frame so that the beamformee can select antennas and provide beamforming vectors accordingly.

In one embodiment, a transceiver calibration system may maximize the backward compatibility to the popular beamforming feedback such that the frame exchange sequence remains the same and only some fields are added. Therefore, it has a good chance to be adopted by the market.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

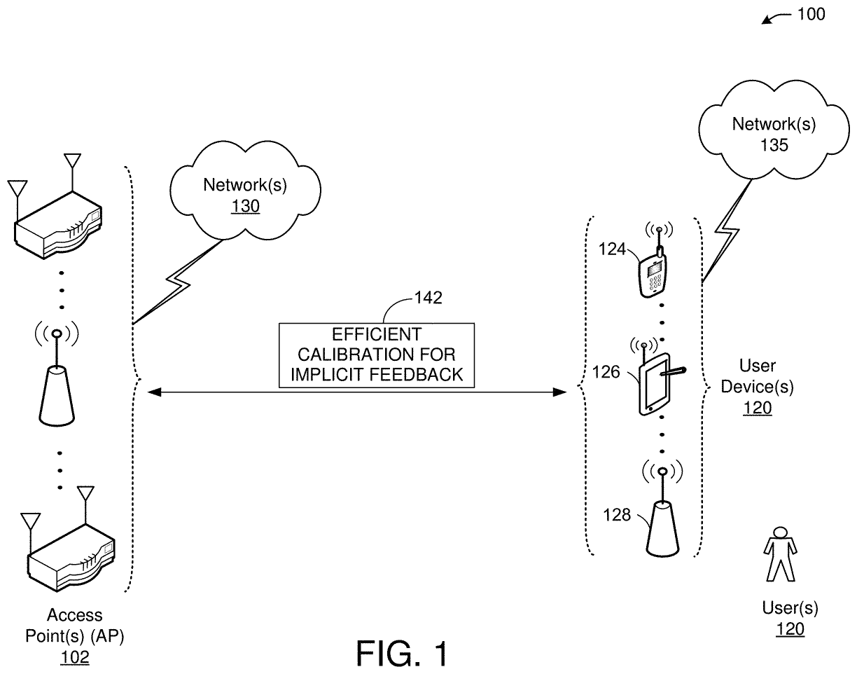

FIG. 1 is a network diagram illustrating an example network environment of efficient calibration for implicit feedback, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

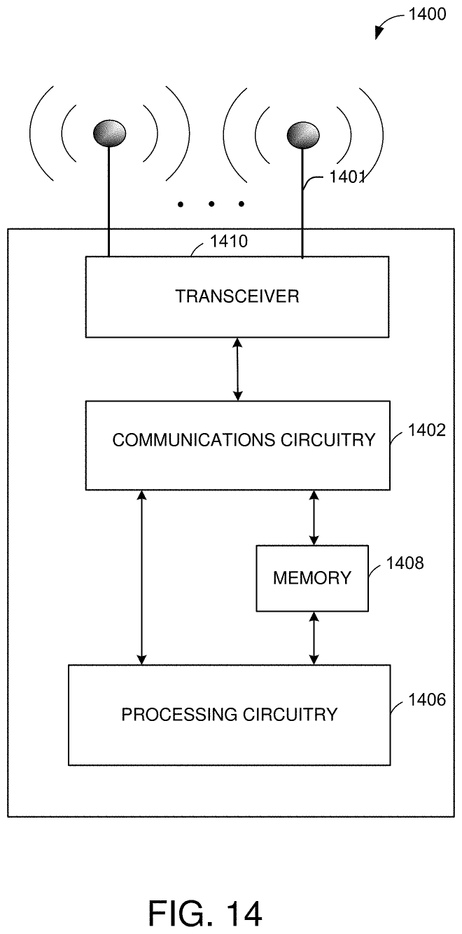

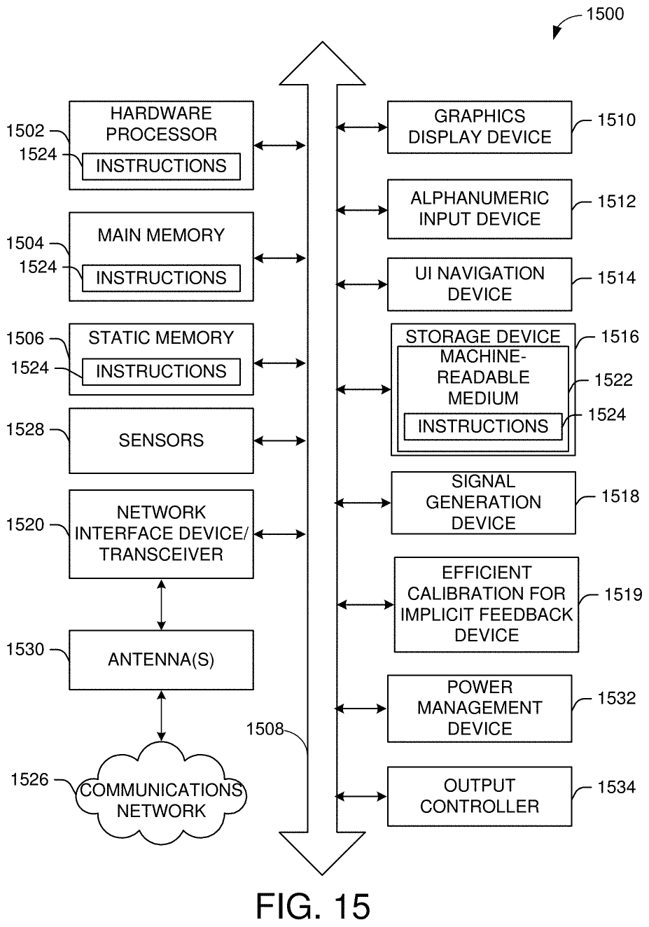

In some embodiments, the user devices 120 and the AP 102 may include one or more computer systems similar to that of the functional diagram of FIG. 14 and/or the example machine/system of FIG. 15.

One or more illustrative user device(s) 120 and/or AP(s) 102 may be operable by one or more user(s) 110. It should be noted that any addressable unit may be a station (STA). An STA may take on multiple distinct characteristics, each of which shapes its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, AP 102 may facilitate efficient calibration for implicit feedback 142 with one or more user devices 120.

In order to prepare communication channels using a plurality of antennas between devices, antenna calibration need to be used. Antenna calibration may be used to remove distortions between the antennas on the communication channels. Further calibration may be used to in order to establish channel reciprocity.

In one or more embodiments, a beamforming feedback vector may be used to help a transmitting device performing calibration on its side (e.g., an AP or an STA) to perform calibration. The beamforming feedback vector may include a quantized feedback vector. This quantized feedback vector may be broken down into angles and then send those to the device. Implicit feedback requires Tx/Rx chain calibration at the transmitter. The feedback vector is used for calibration purpose though it can be used for beamforming in the same time as well. Namely, the calibration feedback may be merged into the beamforming feedback. For example, an STA may quantize a feedback vector and may send resulting one or more quantization indices. The STA may send these quantized indices of the feedback vector to an AP. The one or more quantization indices may be associated with a quantization of a feedback vector, where the quantization of the feedback vector is performed by jointly quantizing first channel estimates from an RX antenna at the STA and each of the plurality of TX antennas at the AP. Joint quantization differentiates from legacy protocols' (e.g., from 802.11n (“11n”)) channel state information (CSI) feedback for radiofrequency (RF) chain calibration of the implicit beamforming feedback. For example, 11n CSI feedback uses scalar quantization instead of vector quantization. The scalar quantization quantizes each element of the feedback vector individually instead of jointly. The separate quantization in 11n has two downsides. First, it is not implemented by the industry. Second, it results in a larger feedback overhead. The joint quantization method results in a smaller quantization overhead and is used by the beamforming feedback in 802.11n, 802.11ac, or 802.11ax.

In one or more embodiments, a transmitting device that may be considered a beamformer (e.g., AP) may need channel estimates of both forward and backward directions for estimating a compensation factor used to calibrate the antennas. The receiving devices (e.g., beamformee) may feed back the channel estimates calculated from one of its receive (RX) antennas. For example, for N×M multiple-input multiple-output (MIMO) channel, the beamformee selects one antenna out of M receive antennas, downgrades the channel to N×1 MISO, and feeds back the beamforming vector of the MISO as the channel vector. The Beamformer uses the fed back beamforming vector as the channel vector in estimating the compensation factors. The channel estimate may be the aggregation of three components: 1) the channel response between Rx and Tx antennas, 2) Tx chain responses, and 3) Rx chain response.

In one or more embodiments, in traditional beamforming feedback, singular value decomposition (SVD) is used in order to decompose a matrix into three matrices. In one or more embodiments, efficient calibration for implicit feedback may omit using SVD during the quantization of the channel responses associated with receiving a sounding frame from a device (e.g., an AP). SVD may refer to a matrix factorization method. SVD may include decomposing a matrix A into a product of three matrices UAV^{T}, where U and V are matrices of singular vectors and A is a diagonal matrix of singular values.

The explicit beamforming feedback for the transmit chain calibration may be used by skipping the SVD step in calculating beamforming feedback. For example, for a MIMO channel with 4 transmit and 2 receive antennas, the channel matrix H is 2 by 4 (2×4). The explicit beamforming feedback calculates the SVD of H and gets a 4×2 beamforming matrix V, which is a unitary matrix. The V matrix is deposed into Givens angles by Givens rotation operations. The Givens angles are then quantized and fed back. In this proposed method, the SVD step is skipped and the H is treated as two 1×4 channels instead of one 2×4 channel. The beamforming vector(s) of one (or two) 1×4 channel(s) is fed back reusing the conventional method (e.g., Givens angles). The one change needed is that the 802.11 standard should allow the beamformer to ask for the beamforming vector for a specific beamformee's receive antenna.

The proposed scheme is fully compatible with the existing implementation. In addition, it is even simpler than the existing by not performing the SVD.

In one or more embodiments, a transceiver calibration for implicit feedback system may facilitate solutions for multiple aspects of transceiver calibration. First, the number of spatial streams in the long training field (LTF) portion is allowed to be different from the number of spatial streams in the data portion so that all the antennas can be excited while the data can be yet reliably received. Second, the feedback duration can be reduced by splitting the calibration load in frequency or data streams such that stations can send calibration feedback simultaneously. Third, the repetition of the LTF symbols is allowed so that the reception quality can be improved for reducing the calibration error. Fourth, the frequency sampling rate for calibration feedback can be lower than the beamforming feedback for reducing overhead. Finally, the antenna mappings between the channel sounding and the calibration feedback needs to be consistent so that the channel estimates received from the sounding and feedback match.

The proposed techniques can improve the efficiency of implicit feedback so that downlink multiuser multiple-input multiple-output (MIMO) can penetrate the market.

It is understood that the above descriptions are for purposes of illustration and are not meant to be limiting.

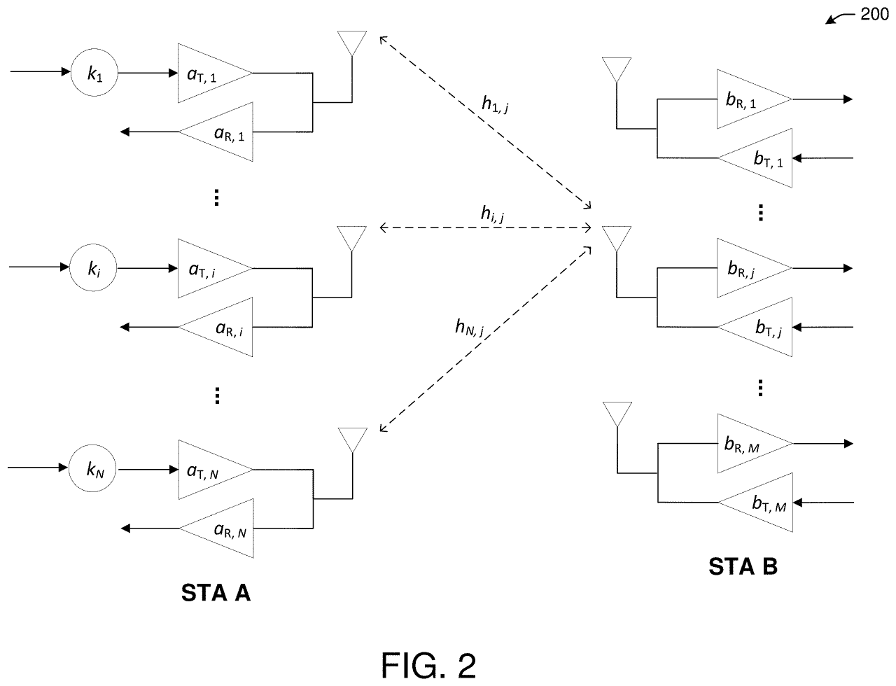

FIG. 2 depicts an illustrative schematic diagram 200 for efficient calibration for implicit feedback, in accordance with one or more example embodiments of the present disclosure.

Referring to FIG. 2, there is shown a signal model for aggregated channel responses between two devices (STA A and STA B). For simplicity, STA A may be an AP and the STA B may be an non-AP STA. Some examples of the channel estimate may be the aggregation of three components: 1) the channel response between Rx and Tx antennas, 2) Tx chain responses, and 3) Rx chain response.

The signal model is illustrated in FIG. 2. STA A and STA B perform channel calibration with each other. The channel response from STA A to STA B with the transceiver responses is given by:

h_{AB,i,j}=a_{T,j}h_{i,j}b_{R,j} (1)

where a_{T,j} is STA A's i-th transmit chain response; b_{R,j} is STA B's j-th receive chain response; h_{i,j} is the channel response between STA A's i-th antenna and STA B's j-th antenna; i=1, 2, . . . , N; J=1, 2, . . . M; N is the number of STA A's antennas; M is the number of STA B's antennas. Similarly, the reverse channel response from STA B to STA A with the transceiver responses is given by:

h_{BA,j,i}=a_{R,i}h_{i,j}b_{T,j} (2)

where a_{R,i} is STA A's i-th receive chain response; b_{T,j} is STA B's j-th transmit chain response.

In general, h_{AB,i,j}≠h_{BA,j,i}. Namely, the bidirectional channel responses with the transceiver chains are not reciprocal in general. However, the channel reciprocity with the transceiver chains is required for the implicit feedback. Therefore, compensation is needed such that the compensated channel responses are reciprocal. The compensation (e.g., a scalar 220) can be applied on the transmit chain of each antenna. Ignoring the small cross-talk among the transmit chains, the compensation is just a scalar multiplied with the input to the transmit chain. For example, the compensation factors kᵢ applied to STA A's transmit chains is illustrated in FIG. 2. With the compensation, the bidirectional channel responses can be reciprocal as:

\tilde{h}_{AB,i,j}=h_{AB,i,j}kᵢ=ρⱼh_{BA,j,i} (3)

where ρⱼ is a scalar constant across all STA A's antennas and only changes across STA B's antennas; kᵢ is the compensation scalar applied to STA A's i-th transmit chain. Substitution of (1) and (2) into (3) gives:

$$\frac{{k}_{t} {a}_{T , i} {b}_{R , j}}{{a}_{R , i} {b}_{T , j}} = {ρ}_{j} , for i = 1 , … , N . \qquad ( 4 )$$

Although the calibrations with different STA B's antennas can result in different sets of compensation factors kᵢ, the ratios among the compensation factors for each set remain the same. Since the ratios remain the same, the beamforming performance remains the same. Therefore, STA A can perform calibration with any of STA B's antennas as long as the signal quality of the select antenna(s) is good. Similarly, compensation can be applied to STA B's transmit chains.

The compensation factors kᵢ can be estimated as follows. STA A sounds the channel using each of its transmit antennas by sending a sounding frame (e.g., an NDP). STA B estimates the channel response h_{AB,i,j}, quantizes it, and sends it back to STA A. Besides, STA B sounds the channel within the channel coherence time such that STA A can estimate h_{BA,j,i}. After these two steps, STA A has both h_{AB,i,j} and h_{Bui}, which are sufficient to estimate kᵢ. An easy estimator is:

$${k}_{i} = \frac{{h}_{BA , j , i}}{{h}_{AB , i , j}} \qquad ( 5 )$$

In one or more embodiments, since the quantization of h_{AB,i,j} is not supported by WiFi chip vendors, the calibration using channel matrix feedback never got into the market. Besides, it is very challenging for the self-calibration to achieve the accuracy for downlink multiuser MIMO (DL MU MIMO). Therefore, implicit feedback is not used by DL MU MIMO in practice. For establishing the channel reciprocity required by implicit feedback, a new way is needed.

In one or more embodiments, beamforming feedback may use Givens rotation. It is proposed to reuse the existing beamforming feedback method for calibration feedback such that almost no implementation complexity is incurred.

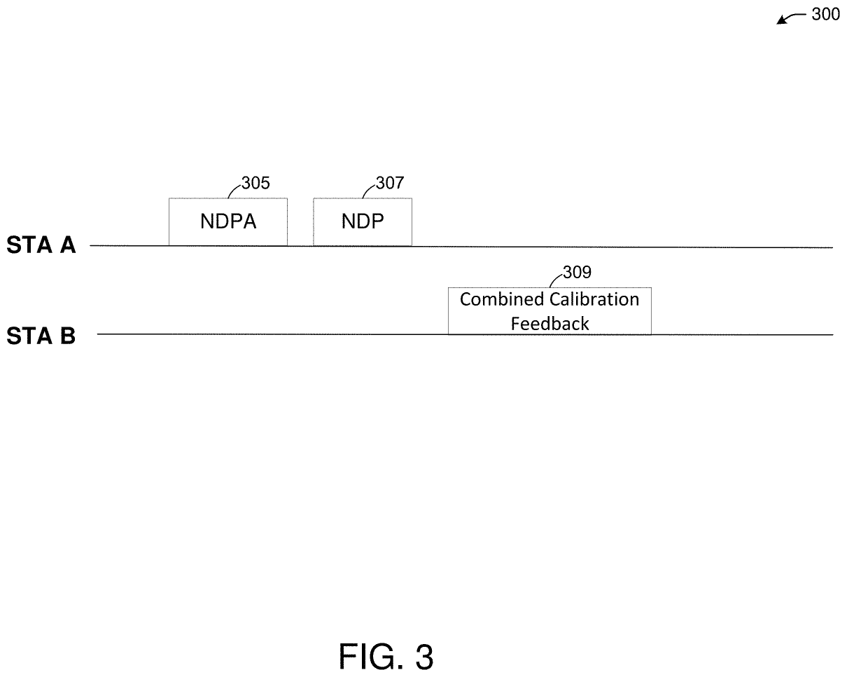

FIG. 3 depicts an illustrative schematic diagram 300 for calibration exchange in single user mode, in accordance with one or more example embodiments of the present disclosure.

In one or more embodiments, STA A initiates the calibration by sending an NDPA 305 that specifies the configurations of the subsequent soundings and the requirements of calibration feedback. STA A then sounds the channel by sending an NDP 307. STA B can sound the channel by sending an NDP frame (not shown here) followed by a frame carrying the calibration feedback. Alternatively, the NDP frame and the calibration feedback frame can be combined into one frame (e.g., combined calibration feedback 309) as shown in FIG. 3. Instead of a dedicated NDP frame, the channel training portion (e.g. LTF symbols) of the combined calibration feedback frame 309, which combines an NDP frame and a calibration feedback frame, which serves as the channel sounding signal.

For minimizing the implementation complexity and maximizing the backward compatibility, the beamforming feedback for calibration feedback may be reused. It is easy to understand the concept when the STA B only has one antenna. In this case, the difference between the beamforming feedback and the channel feedback is just a normalization factor. More precisely, channel feedback sends quantized h_{AB,i,j}, for i=1 to N, for each STA A's antenna while beamforming feedback sends the quantized Givens angles corresponding to the normalized channel vector

$$\frac{1}{\sqrt{{Σ}_{i} {‖ {h}_{AB , i , 1} ‖}^{2}}} [ \begin{matrix}{h}_{AB , 1 , 1} & … & {h}_{AB , N , 1}\end{matrix} ] ,$$

where

$$\frac{1}{\sqrt{{Σ}_{i} {‖ {h}_{AB , i , 1} ‖}^{2}}}$$

is the power normalization factor of the channel vector [h_{AB,i,1} . . . h_{AB,N,1}]. Since the transmitter STA A only needs to compensate for the relative differences (in phases and/or amplitudes) across the transmit chains the normalization factor is not useful. Namely, the normalization factor does not affect the beamforming. For the single stream beamforming in single user mode, only the relative phase differences are needed. For multiple streams, the relative differences of both phases and amplitudes are needed. It should be noticed that STA A not only calibrates the transmit chains but also acquires the beamforming vector to beamform the data to STA B after receiving the sounding and beamforming feedback (or calibration feedback) from STA B.

In one or more embodiments, if STA B has multiple antennas, STA A (or STA B) can pick an antenna of STA B (e.g. antenna 1), whose indication can be in NDPA frame or trigger frame or feedback frame, and asks STA B to send the beamforming feedback for that antennas as if STA B would only use that antenna to receive a single beamformed data stream. Namely, the quantized Givens angles for a single beamforming vectors per subcarrier or every Ng subcarriers are fed back by STA B. This is sufficient for STA A to calibrate or compensate its transmit chains. For robustness in fading channels, STA A (or STA B) may pick more than one antennas (e.g. Ne antennas) and ask STA B to feed back the beamforming vectors for each of the picked antennas, respectively as if STA B would only use each of the picked antennas to receive a single beamformed data stream one at a time. After receiving the beamforming feedbacks, STA A uses them together with the corresponding channel sounding from the picked antennas to calibrate and compensate STA A's transmit chains. For fully sounding the channel, STA B may send sounding signals using all of its antennas instead of the picked ones. The sounding signals can be in a dedicated NDP frame or the channel training portion of the feedback frame i.e. the combined calibration feedback frame 309 in FIG. 3, which carries the beamforming feedbacks.

In one or more embodiments, quantized Givens angles for the beamforming matrix are sent in the order shown in the table below.

TABLE 1
order of angles in compressed beamforming report field.

| | Number of | The order of angles in the Quantized |
|---|---|---|
| Size of V | angles | Beamforming Feedback Matrices |
| (Nr × Ne) | (Na) | Information field |
| 2 × 1 | 2 | ϕ11, ψ21 |
| 2 × 2 | 2 | ϕ11, ψ21 |
| 3 × 1 | 4 | ϕ11, ϕ21, ψ21, ψ31 |
| 3 × 2 | 6 | ϕ11, ϕ21, ψ21, ψ31, ϕ22, ψ32 |
| 3 × 3 | 6 | ϕ11, ϕ21, ψ21, ψ31, ϕ22, ψ32 |
| 4 × 1 | 6 | ϕ11, ϕ21, ϕ31, ψ21, ψ31, ψ41 |
| 4 × 2 | 10 | ϕ11, ϕ21, ϕ31, ψ21, ψ31, ψ41, ϕ22, ϕ32, ψ32, |
| | | ψ42 |
| 4 × 3 | 12 | ϕ11, ϕ21, ϕ31, ψ21, ψ31, ψ41, ϕ22, ϕ32, ψ32, |
| | | ψ42, ϕ33, ψ43 |
| 4 × 4 | 12 | ϕ11, ϕ21, ϕ31, ψ21, ψ31, ψ41, ϕ22, ϕ32, ψ32, |
| | | ψ42, ϕ33, ψ43 |

In one or more embodiments, a convention is followed and modified for reporting Ne Nr×1 beamforming vectors as illustrated in Table 2, where Ne is the number of beamformee's antennas selected for calibration; Nr is the number of beamformer's antennas.

TABLE 2
Angle order in calibration report with antenna first order.

| Beamforming | Number of | |
|---|---|---|
| vectors | angles | The order of angles in beamforming report |
| 1 2 × 1 vector | 2 | Φ11, Ψ21 |
| 2 2 × 1 vectors | 4 | Φ11, Ψ21 for the 1^{st} antenna; Φ11, Ψ21 for |
| | | the 2^{nd} antenna |
| 1 3 × 1 vector | 4 | Φ11, Φ21, Ψ21, Ψ31 |
| 2 3 × 1 vectors | 8 | Φ11, Φ21, Ψ21, Ψ31 for the 1^{st} antenna; |
| | | Φ11, Φ21, Ψ21, Ψ31 for the 2^{nd} antenna |
| 1 4 × 1 vector | 6 | Φ11, Φ21, Φ31, Ψ21, Ψ31, Ψ41 |
| 2 4 × 1 vectors | 12 | Φ11, Φ21, Φ31, Ψ21, Ψ31, Ψ41 for the |
| | | 1^{st} antenna; Φ11, Φ21, Φ31, Ψ21, Ψ31, Ψ41 |
| | | for the 2^{nd} antenna |
| . . . | . . . | . . . |

The order in Table 2 is antenna first, which is similar to the existing beamforming feedback. After the angles for one subcarrier are sent, the angles for the next feedback subcarrier are sent. Alternatively, the frequency may be done first. Namely, the angles for one antenna and one subcarrier are sent and then the angles for the same antenna and the next feedback subcarrier are sent. After all the angles for the same antennas are sent, the angles for the next selected antenna are sent.

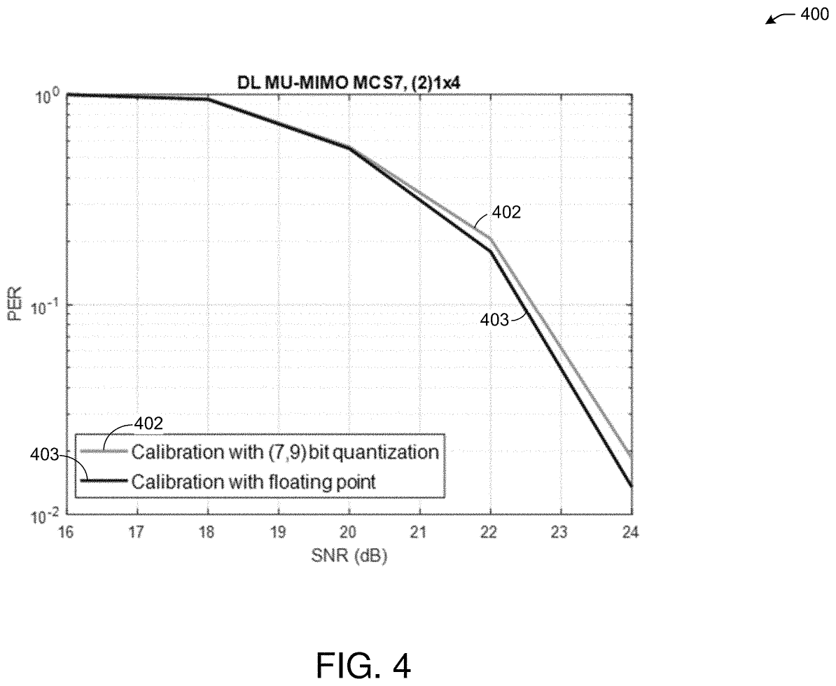

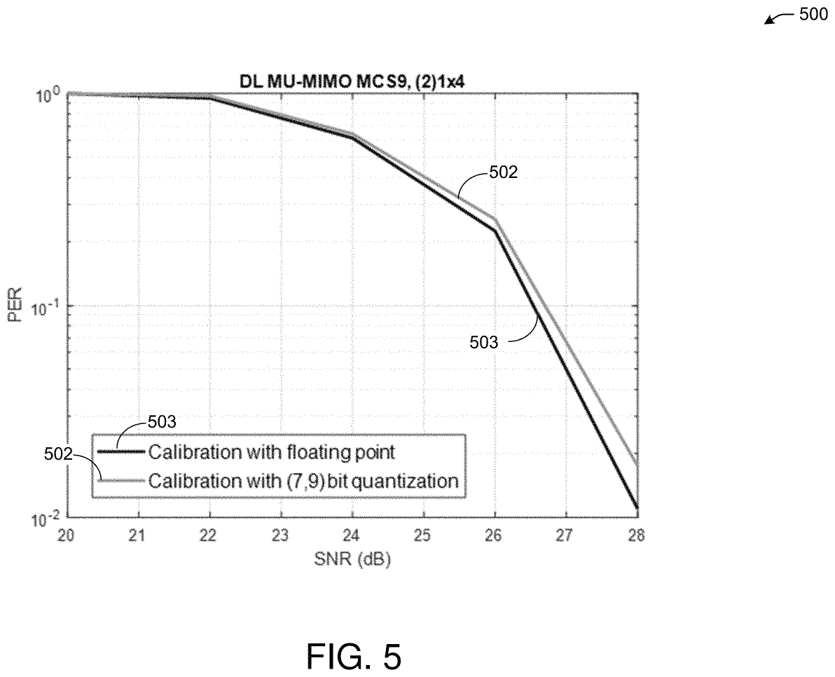

FIGS. 4-5 depict illustrative schematic diagrams 400 and 500 for packet error ratio (PER) plots, in accordance with one or more example embodiments of the present disclosure.

In one or more embodiments, the proposed scheme may be simulated and compared with the calibration with infinite feedback resolution. The simulation assumptions are as follows. AP has 4 antennas and each STA has 1 antenna. Downlink multiuser MIMO is simulated. There are one AP and two STAs. Implicit feedback is used. Each transmit or receive chain has a different response. The downlink sounding has 10 dB higher power than the uplink sounding. Two calibration schemes are compared, one with floating point feedback (e.g., lines 403 of FIG. 4 and 503 of FIG. 5) and the other with 802.11n (7, 9) bit quantization. Packet error rates (PER) for MCS7 and MCS9 (e.g., lines 402 of FIG. 4 and 502 of FIG. 5) are plotted in FIGS. 4 and 5, respectively. It can be seen from the plots that the proposed calibration scheme works almost the same as the one with infinite resolution in calibration feedback, e.g. within 0.2 dB.

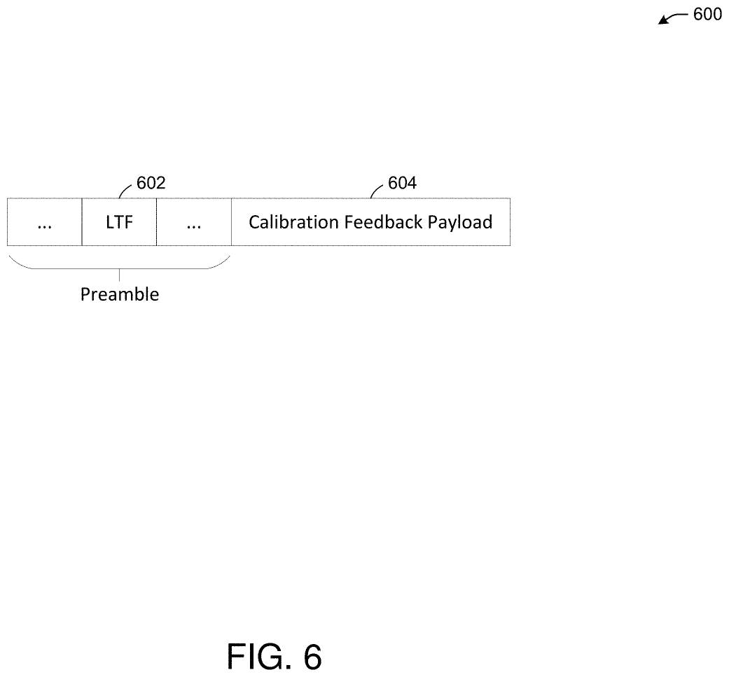

FIG. 6 depicts an illustrative schematic diagram 600 for PPDU format of calibration feedback, in accordance with one or more example embodiments of the present disclosure.

In one or more embodiments, if the calibration feedback and the channel sounding sent by the same device are sent separately in two different frames, there is no problem. However, the efficiency is low because of the extra overhead short inter-frame space (SIFS) and preambles. A more efficient way is illustrated in FIG. 6. The channel sounding and the calibration feedback are combined into one PPDU. The long training field (LTF) portion 602 of the PPDU serves as the channel sounding.

In FIG. 6, the channel training portion i.e. LTF that is for the demodulation of the payload can be used as the implicit feedback i.e. the channel sounding signal from the beamformee to the beamformer. The number of antennas excited in the long training field (LTF) can be greater than the number of antennas whose beamforming vectors are in the calibration feedback. For example, the AP has 4 antennas and the STA has 2 antennas. The calibration feedback is the beamforming vectors for the 1^{st} antenna of the STA's two antennas. The STA calculates the beamforming vectors assuming the AP uses 4 antennas and the STA only uses the 1^{st} antenna to receive the beamforming signal. The calibration feedback payload 604 is sent by a PPDU. The LTF of the PPDU consists of two LTF symbols encoded by 2×2 P-matrix codes for carrying the sounding signals of the STA's two antennas. The calibration feedback payload can sent by two (or one) spatial streams whose channels are trained by the two LTF symbols.

From the channel sounding point of view, it is desired that all antennas are excited. Namely, each antenna is allocated a separate spatial stream so that the channels from each sounded transmit antenna to all the receive antennas can be learned by the device receiving the sounding. From the calibration feedback point of view, it is not necessary that each antenna sends a separate data stream. For example, AP has 8 antennas and two STAs each have 4 antennas. AP prefers STAs sound the channel using all 8 antennas. From the data reception point of view, since it is unreliable for AP to receive 8 spatial streams using 8 antennas, AP may prefers each STA sends 3 instead of 4 data streams. Therefore, it is desirable that the LTF portion and the data portion may support different numbers of spatial streams. The calibration NDPA frame and the feedback trigger frame of the transceiver calibration process may specify the numbers of spatial streams in the LTF portion and the data portion, respectively. Besides NDPA and trigger frame, the preamble of calibration feedback PPDU may be another place for specifying the different numbers of spatial streams. In the conventional scheme, the transmission power of each spatial stream remains the same over the LTF portion and the data portion. If the numbers of the spatial streams are different between the LTF portion and the data portion in the calibration feedback PPDU, it is desirable that the power of each spatial stream can be different over the data portion and the LTF portion. For fully utilizing the transmission power, the per-stream power may be higher in the data portion if the number of streams is less. However, from peak to average power ratio (PAPR) perspective, since the LTF portion has a lower PAPR than the data portion, the per-stream power may be higher in the LTF portion. The difference or ratio of the two power levels may be specified in the 802.11 standard or NDPA or trigger frame or the preamble of the feedback frame.

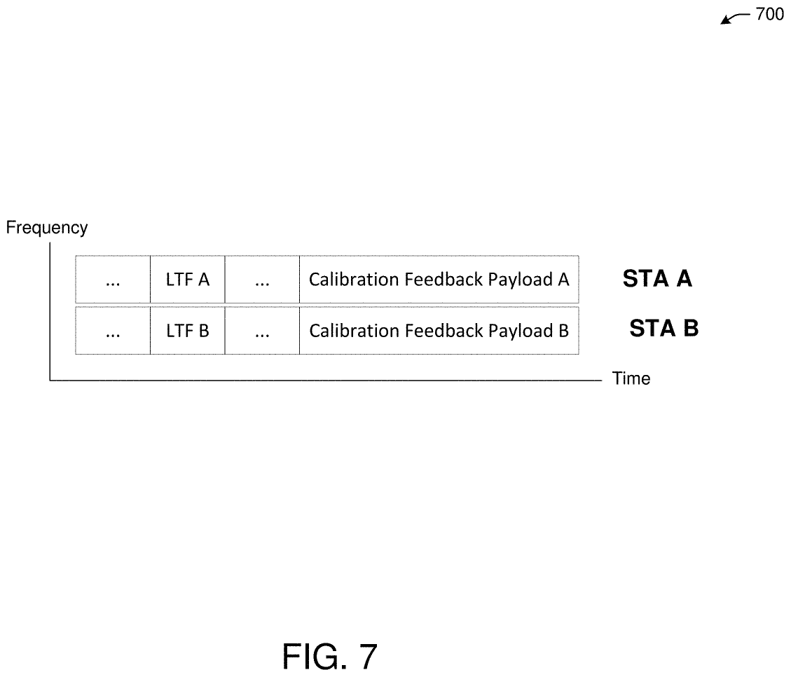

FIG. 7 depicts an illustrative schematic diagram 700 for transceiver calibration for implicit feedback, in accordance with one or more example embodiments of the present disclosure.

Referring to FIG. 7, there is shown calibration feedbacks that are sent by OFDMA.

For reducing the transmission time of the calibration feedback, the AP may split the calibration feedback across multiple stations as illustrated in FIG. 7. The calibration feedback can be split in terms of frequency sub-bands (or resource units) or/and spatial streams. For example in FIG. 7, the AP let STA A and STA B provide calibration information for different parts of the frequency band. STA A and STA B share the channel using OFDMA.

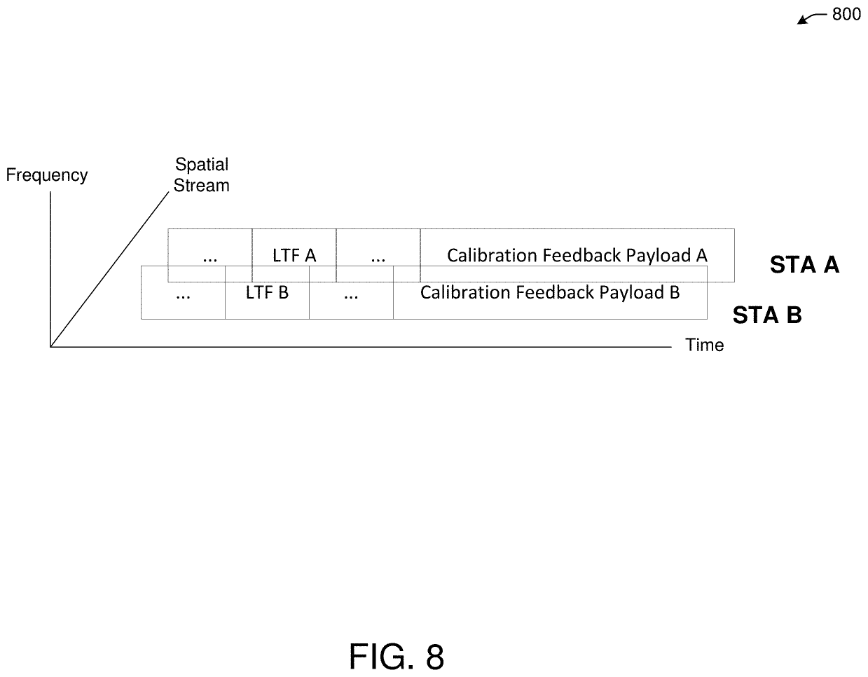

FIG. 8 depicts an illustrative schematic diagram 800 for transceiver calibration for implicit feedback, in accordance with one or more example embodiments of the present disclosure.

Referring to FIG. 8, there is shown calibration feedbacks that are sent by MU MIMO.

For another example, STA A and STA B may share the channel using UL MU-MIMO as illustrated in FIG. 8. The calibration feedback payloads of STA A and STA B may be for different sub-bands (or resource units) or different station antennas. In one example of FIG. 8, STA A may sound the full band for its two antennas and STA B may do the same. In STA A's feedback payload, STA A only sends the feedback e.g. the beamforming vectors for one of its two antennas. Similarly, in STA B's feedback payload, STA B only sends the feedback e.g. the beamforming vectors for one of its two antennas. After receiving the feedback, AP calibrates its transceiver chains using either STA A's feedback or STA B's feedback. AP can also use both feedbacks and do an averaging to improve the accuracy. For further reducing the feedback transmission time, AP can ask STA A and STA B fully sound the channel in terms of frequency and antennas e.g. via 4×4 P-matrix. In addition, AP asks STA A to feed back the calibration feedback for one of STA A's antenna and part of the subcarriers e.g. half of the band or odd subcarriers and asks STA B to feed back the calibration feedback for one of STA B's antenna and the remaining part of the subcarriers e.g. another half of the band or even subcarriers.

Since the channel is fully sounded by all the antennas, AP can estimate the full channel matrix after AP's transceiver chains get calibrated. For the calibration, AP only requires that the split feedbacks (i.e. the beamforming vectors) cover the full frequency band. If the split feedbacks cover the band twice, AP gets two sets of calibration data and can apply averaging for improving the accuracy.

For reducing the transmission time, AP may do the calibration with one or multiple devices with good channel quality e.g. a close user or another AP. The good channel quality supports high MCSs and thus high data rate and short transmission duration. If the calibration feedbacks are split among users, the user with better channel quality may send a larger share of the feedbacks.

For improving the channel sounding quality and/or the calibration accuracy, the power of the LTF signal may be boosted in the calibration process or the implicit feedback process. In addition or alternatively, the transmission of the LTF signal may be repeated so that the receiver can combine the received signals for improving the channel estimation accuracy. The number of LTF copies or repetitions may be specified in the payload of the NDPA frame or the trigger frame or in the preamble of the NDP or the calibration feedback frame. Not limited to implicit/calibration feedback, the idea of LTF repetition can be applied to any PPDU where the channel training needs to be improved. As an alternative or addition, a long LTF duration may be used for improving channel training. For example, 4×LTF instead of 1×LTF may be used for channel sounding/training.

Since the transceiver chain response is flat across frequency as compared with the fading channel response, the frequency sampling rate of calibration feedback doesn't need to be as high as the beamforming feedback for reducing the feedback overhead. For example, Ng=16 or Ng=32 or Ng=64 may be good enough. Namely, the calibration feedback may be for every 16 or 32 or 64 subcarriers instead of every subcarrier. On the other hand, one may still use the high frequency sampling rates for combating noise via smoothing (or averaging or low pass filtering assuming the initial estimation error is i.i.d.).

The order of antennas in the calibration feedback and the one in the channel sounding need to be consistent. For example, if AP asks STA to provide calibration feedback for the STA's antennas 1 and 2, then STA should provide the calibration feedback for antennas 1 and 2 and should also sound the channel using antennas 1 and 2 in the same order as in the feedback. Besides antennas 1 and 2, STA may also sound other antennas e.g. using P-matrix codes 3 and 4 instead of codes 1 and 2.

For another example, if AP asks STA to provide calibration feedback for two of the STA's antennas, then STA picks two antennas, denotes them as the first two antennas i.e. antennas 1 and 2, sounds the channel using antennas 1 and 2, and provides calibration feedback i.e. the beamforming vectors for the beamforming to each of the picked antennas in the same order as in the channel sounding. Besides the picked antennas, STA may also sound other antennas. The sounding signal can be in a dedicated NDP frame or can be part of the LTF field of the calibration feedback frame.

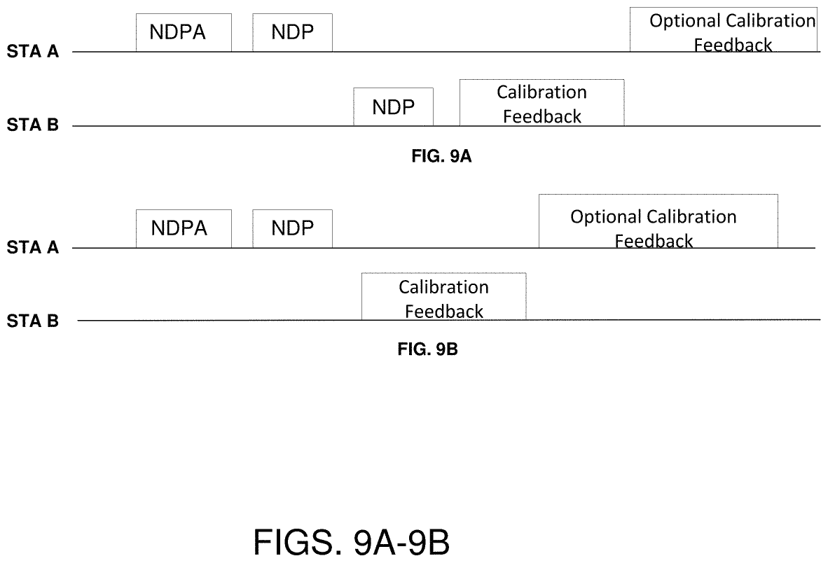

FIGS. 9A-9B depict illustrative schematic diagrams for transceiver calibration, in accordance with one or more example embodiments of the present disclosure.

In one or more embodiments, a transceiver calibration system may be used for calibrating the transceiver chains of the beamformer or beamformee. In addition, it can replace the existing explicit beamforming feedback protocol. The reason is that the beamformer also acquires the channel matrix from the beamformer to the beamformee during the calibration process. What is more, the calibration feedback overhead is much lower than that of the explicit beamforming feedback, 2(Nr−1) angles vs. Nc (2Nr−Nc−1), where Nr is the number of beamformer's antennas; Nc is the number of beamformed spatial streams.

The frame exchange sequences for single user mode is illustrated in FIGS. 9A-9B. STA A initiates the calibration by sending an NDPA that specifies the configurations of the subsequent soundings and the requirements of calibration feedback. STA A then sounds the channel by sending an NDP. In Option of FIG. 9A, STA B sounds the channel by sending an NDP frame followed by a frame carrying the calibration feedback. In Option of FIG. 9B, the NDP frame and the calibration feedback frame can be combined into one frame. Instead of a dedicated NDP frame, the channel training portion (e.g. LTF symbols) of the calibration feedback frame serves as the channel sounding signal.

The optional calibration feedback frame in FIGS. 9A-9B is for STA B to calibrate and compensate its transmit chains so that STA B can beamform to STA A. The calibration feedback frames may be of action-no-ack type or may require acknowledgments.

In general, the proposed calibration scheme can be well fit into the existing explicit beamforming feedback schemes defined in 11n/ac/ax. All these existing schemes start with a sounding frame from the beamformer followed by a beamforming feedback frame from the beamformee. For 11ax, a feedback trigger frame sent by the beamformer may sit between the beamformer's sounding and the beamformee's feedback. It may be needed to replace the beamformee's beamforming feedback with the calibration feedback and use the channel training portion of the calibration feedback frame as the channel sounding signals (or the implicit feedback) for the beamformer. As described earlier, the calibration feedback is nothing but the beamforming feedback for a MISO channel assuming the beamformee using only a specific antenna to receive the beamformed signal from the beamformer. Correspondingly, if the beamformee feeds back the calibration feedback for a specific antenna, the beamformee also sounds the channel using that the antenna without any additional beamforming weight. The beamformee's channel sounding signal can be the channel training portion of the frame e.g. LTFs carrying the calibration feedback. Or, the beamformee's channel sounding signal can be in a dedicated frame e.g. an NDP frame.

FIG. 9A is compatible with the single user ranging scheme of 802.11az. Option of FIG. 9B is compatible with the single user beamforming sounding/feedback of 802.11ax.

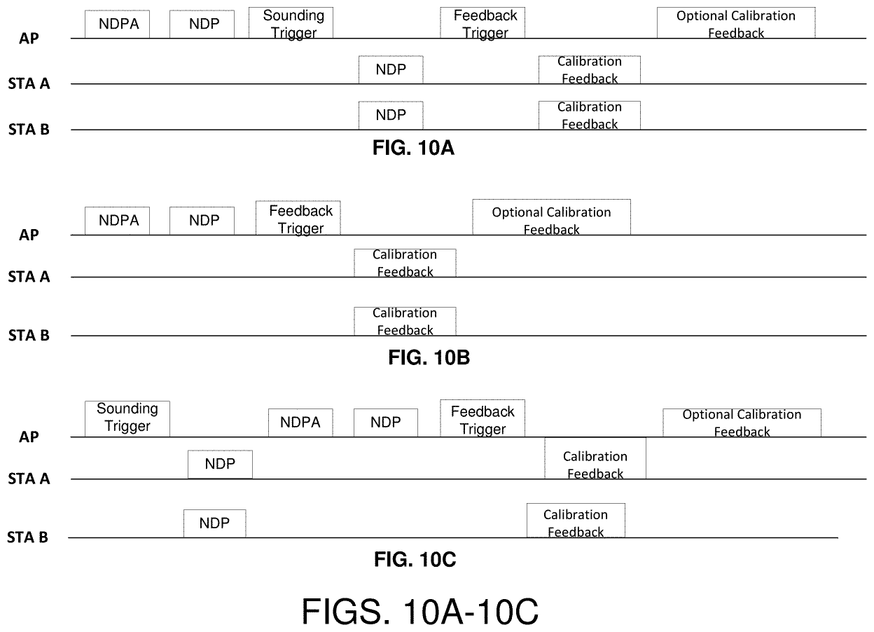

FIGS. 10A-10C depict illustrative schematic diagrams for transceiver calibration, in accordance with one or more example embodiments of the present disclosure.

Referring to FIGS. 10A-10C, there is shown calibration and implicit feedback for multiuser mode.

FIGS. 10A-10C show some examples for multiuser mode. In FIGS. 10A-10C, the sounding trigger can solicit sounding signals e.g. NDPs from the stations. The sounding signals can share the channel using P-matrix code multiplexing or time division multiplexing or frequency division multiplexing or a mix of the previous multiplexing schemes. The sounding trigger can solicit one or multiple sounding signals from one or multiple stations. Multiple sounding triggers may be used. For example, one trigger frame is sent to one station and three trigger+NDP combinations are lined up in time for three stations. Similarly, the feedback trigger can solicit calibration feedback or beamforming feedback or the implicit feedback carried by the channel training portion of the feedback frame. The feedback signals can share the channel using P-matrix code multiplexing (e.g. for implicit feedback) or time division multiplexing (e.g. for calibration or beamforming feedback) or frequency division multiplexing (e.g. for calibration or beamforming feedback) or a mix of the previous multiplexing schemes. The feedback trigger can solicit one or multiple feedback signals from one or multiple stations. Multiple feedback triggers may be used. For example, one trigger frame is sent to one station and three trigger+feedback combinations are lined up in time for three stations.

The optional calibration feedback frame in FIGS. 10A-10C is for the station to calibrate and compensate its transmit chains so that the station can beamform to the AP. The calibration feedback frames may be of action-no-ack type or may require acknowledgments.

In Option of FIG. 10B is very similar to or compatible with 802.11ax. Option of FIG. 10C is very similar to or compatible with 802.11az. Option of FIG. 10A is a variant of Option of FIG. 10B. Option of FIG. 10A uses one or multiple dedicated sounding trigger frames for asking the stations to send the channel sounding signals i.e. NDP frames. Besides, Option of FIG. 10A uses one or multiple dedicated feedback trigger frames for asking the stations to send the calibration or beamforming feedbacks. By splitting the sounding signals and feedbacks into different frames, it relaxes the implementation requirements and increases the flexibility at the cost of efficiency. It is understood that the above descriptions are for purposes of illustration and are not meant to be limiting.

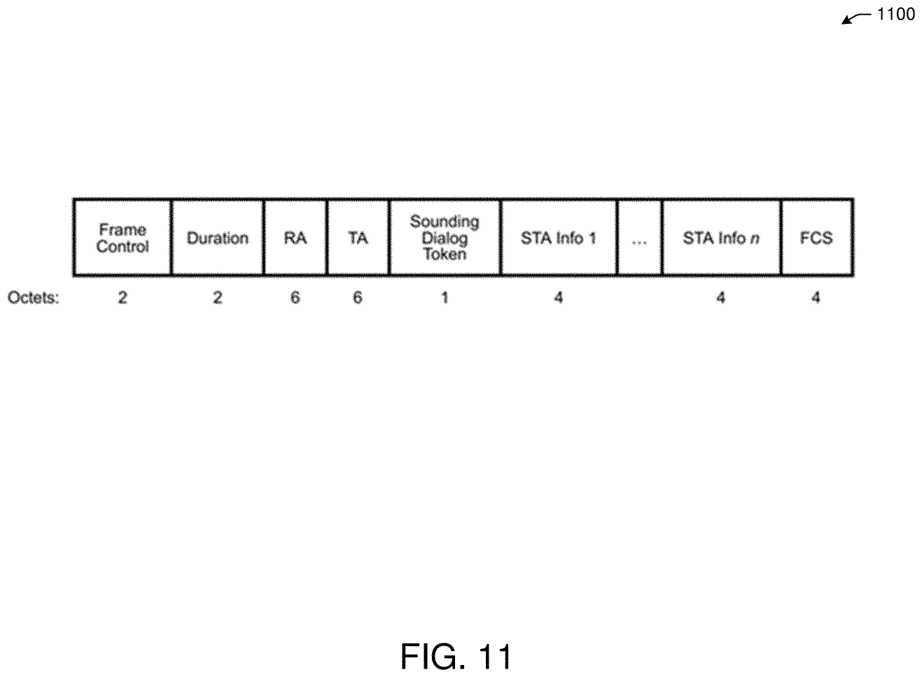

FIG. 11 depicts an illustrative schematic diagram 1100 for transceiver calibration, in accordance with one or more example embodiments of the present disclosure.

One or multiple new MAC frames may be needed. For example, a new NDPA frame for announcing calibration sounding and soliciting calibration feedback is needed. For another example, a new sounding trigger and a new feedback trigger for calibration sounding and feedback may be needed.

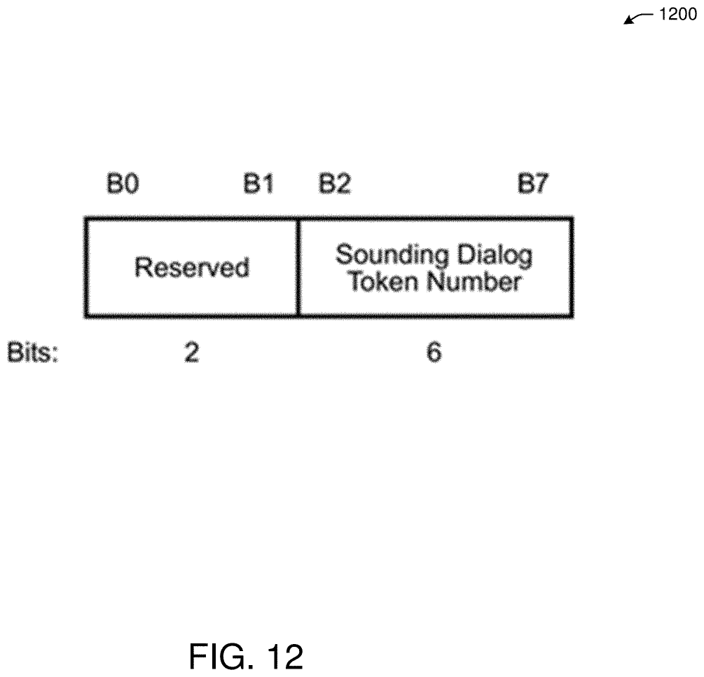

Referring to FIG. 11, there is shown a high efficiency (HE) null data packet announcement (NDPA) frame format. This may be modified for the calibration NDPA. For example, one frame type or sub-type may be added by modifying the frame control field in FIG. 11. For another example, an entry may be added for the calibration NDPA by reusing the existing NDPA frames e.g. VHT NDPA and HE NDPA (or 11ax NDPA) and 11az NDPA. Currently, 11ax NDPA and 11az NDP are indicated by flipping one reserved bit, respectively in the sounding dialog token field. The first two bits of the sounding dialog token was initially reserved as shown in FIG. 12.

FIG. 12 depicts an illustrative schematic diagram 1200 for transceiver calibration, in accordance with one or more example embodiments of the present disclosure.

Referring to FIG. 12, there is shown the sounding dialog token field in VHT NDPA.

802.11ax NDPA flipped one of them to signal 11ax NDPA and 11az NDPA flipped the other to signal 11az NDPA. For adding the calibration NDPA into the existing NDPA format, it may be needed to take one entry out of the four entries that can be indicated by the two bits initially reserved. In addition, since 11ax NDPA and 11az NDPA took essentially two entries each from the four entries as is, it may be needed to submit comments to 11ax and 11az task groups so that 11ax NDPA and 11az NDPA take two entries out of four in total and leave two entries available.

In the STA info field or a field common to all STAs in the NDPA and trigger frames for calibration, the number of selected antennas or antenna index(es) is indicated. For each of the selected antennas, the beamforming vectors for the beamforming to the selected antenna are fed back in the calibration feedback. Other indications in the STA info field or calibration NDPA/trigger may be similar to those of the beamforming feedback e.g. the subcarrier grouping factor Ng and the number of transmit (beamforming) antennas Nr.

It is understood that the above descriptions are for purposes of illustration and are not meant to be limiting.

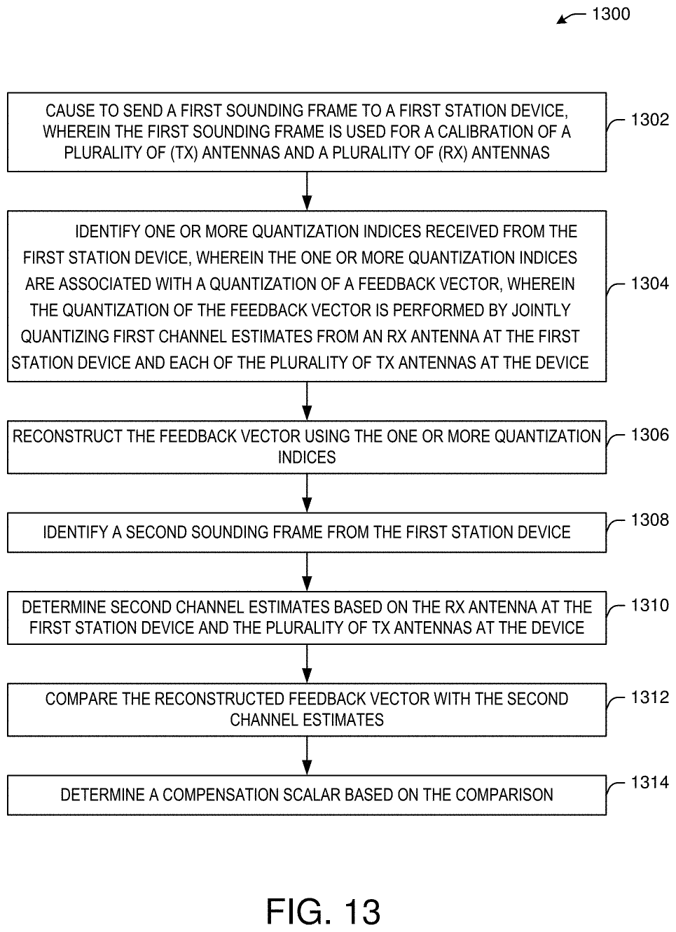

FIG. 13 illustrates a flow diagram of illustrative process 1300 for an efficient calibration for implicit feedback system, in accordance with one or more example embodiments of the present disclosure.

At block 1302, a device (e.g., the user device(s) 120 and/or the AP 102 of FIG. 1) may cause to send a first sounding frame to a first station device, wherein the first sounding frame is used for calibration of a plurality of (TX) antennas and a plurality of (RX) antennas. The calibration may be initiated by sending a null data packet announcement (NDPA) frame or a trigger frame.

At block 1304, the device may identify one or more quantization indices received from the first station device, wherein the one or more quantization indices are associated with a quantization of a feedback vector, wherein the quantization of the feedback vector is performed by jointly quantizing first channel estimates from an RX antenna at the first station device and each of the plurality of TX antennas at the device. Joint quantization differentiates from legacy protocols (e.g., from 802.11n (“11n”) channel state information (CSI) feedback for the radiofrequency (RF) chain calibration of the implicit beamforming feedback. For example, 11n CSI feedback uses scalar quantization instead of vector quantization. The scalar quantization quantizes each element of the feedback vector individually instead of jointly. The separate quantization in 11n has two downsides. First, it is not implemented by the industry. Second, it results in a larger feedback overhead. The joint quantization method results in a smaller quantization overhead and is used by the beamforming feedback in 802.11n, 802.11ac, or 802.11ax.

At block 1306, the device may reconstruct the feedback vector using the one or more quantization indices.

At block 1308, the device may identify a second sounding frame from the first station device. The second sounding frame may be a null data packet (NDP) frame received from the first station device. The second sounding frame may be a combination calibration feedback frame or any frame with data comprising one or more long training fields (LTFs). The one or more LTFs are used for channel estimation.

At block 1310, the device may determine second channel estimates based on the RX antenna at the first station device and the plurality of TX antennas at the device.

At block 1312, the device may compare the reconstructed feedback vector with the second channel estimates.

At block 1314, the device may determine a compensation scalar based on the comparison. The compensation scalar may be used to compensate for a difference between a transmit chain and a corresponding receive chain connected to a same TX antenna at the device. The device may determine that ratios of a transmit chain response to a corresponding receive chain response remains the same for the plurality of TX antennas. After calibrating the one or more TX and one or more RX antennas, the device may send one or more data frames on the plurality of the TX antennas by applying the compensation scalar to the one or more data frames.

It is understood that the above descriptions are for purposes of illustration and are not meant to be limiting.

FIG. 14 shows a functional diagram of an exemplary communication station 1400, in accordance with one or more example embodiments of the present disclosure. In one embodiment, FIG. 14 illustrates a functional block diagram of a communication station that may be suitable for use as an AP 102 (FIG. 1) or a user device 120 (FIG. 1) in accordance with some embodiments. The communication station 1400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1400 may include communications circuitry 1402 and a transceiver 1410 for transmitting and receiving signals to and from other communication stations using one or more antennas 1401. The communications circuitry 1402 may include circuitry that can operate the physical layer (PHY) communications and/or medium access control (MAC) communications for controlling access to the wireless medium, and/or any other communications layers for transmitting and receiving signals. The communication station 1400 may also include processing circuitry 1406 and memory 1408 arranged to perform the operations described herein. In some embodiments, the communications circuitry 1402 and the processing circuitry 1406 may be configured to perform operations detailed in the above figures, diagrams, and flows.

In accordance with some embodiments, the communications circuitry 1402 may be arranged to contend for a wireless medium and configure frames or packets for communicating over the wireless medium. The communications circuitry 1402 may be arranged to transmit and receive signals. The communications circuitry 1402 may also include circuitry for modulation/demodulation, upconversion/downconversion, filtering, amplification, etc. In some embodiments, the processing circuitry 1406 of the communication station 1400 may include one or more processors. In other embodiments, two or more antennas 1401 may be coupled to the communications circuitry 1402 arranged for sending and receiving signals. The memory 1408 may store information for configuring the processing circuitry 1406 to perform operations for configuring and transmitting message frames and performing the various operations described herein. The memory 1408 may include any type of memory, including non-transitory memory, for storing information in a form readable by a machine (e.g., a computer). For example, the memory 1408 may include a computer-readable storage device, read-only memory (ROM), random-access memory (RAM), magnetic disk storage media, optical storage media, flash-memory devices and other storage devices and media.

In some embodiments, the communication station 1400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1400 may include one or more antennas 1401. The antennas 1401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1400 may include one or more of a keyboard, a display, a non-volatile memory port, multiple antennas, a graphics processor, an application processor, speakers, and other mobile device elements. The display may be an LCD screen including a touch screen.

Although the communication station 1400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1400 may include one or more processors and may be configured with instructions stored on a computer-readable storage device.

FIG. 15 illustrates a block diagram of an example of a machine 1500 or system upon which any one or more of the techniques (e.g., methodologies) discussed herein may be performed. In other embodiments, the machine 1500 may operate as a standalone device or may be connected (e.g., networked) to other machines. In a networked deployment, the machine 1500 may operate in the capacity of a server machine, a client machine, or both in server-client network environments. In an example, the machine 1500 may act as a peer machine in peer-to-peer (P2P) (or other distributed) network environments. The machine 1500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1500 may include a hardware processor 1502 (e.g., a central processing unit (CPU), a graphics processing unit (GPU), a hardware processor core, or any combination thereof), a main memory 1504 and a static memory 1506, some or all of which may communicate with each other via an interlink (e.g., bus) 1508. The machine 1500 may further include a power management device 1532, a graphics display device 1510, an alphanumeric input device 1512 (e.g., a keyboard), and a user interface (UI) navigation device 1514 (e.g., a mouse). In an example, the graphics display device 1510, alphanumeric input device 1512, and UI navigation device 1514 may be a touch screen display. The machine 1500 may additionally include a storage device (i.e., drive unit) 1516, a signal generation device 1518 (e.g., a speaker), an efficient calibration for implicit feedback device 1519, a network interface device/transceiver 1520 coupled to antenna(s) 1530, and one or more sensors 1528, such as a global positioning system (GPS) sensor, a compass, an accelerometer, or other sensor. The machine 1500 may include an output controller 1534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1502 for generation and processing of the baseband signals and for controlling operations of the main memory 1504, the storage device 1516, and/or the efficient calibration for implicit feedback device 1519. The baseband processor may be provided on a single radio card, a single chip, or an integrated circuit (IC).

The storage device 1516 may include a machine readable medium 1522 on which is stored one or more sets of data structures or instructions 1524 (e.g., software) embodying or utilized by any one or more of the techniques or functions described herein. The instructions 1524 may also reside, completely or at least partially, within the main memory 1504, within the static memory 1506, or within the hardware processor 1502 during execution thereof by the machine 1500. In an example, one or any combination of the hardware processor 1502, the main memory 1504, the static memory 1506, or the storage device 1516 may constitute machine-readable media.

The efficient calibration for implicit feedback device 1519 may carry out or perform any of the operations and processes (e.g., process 1300) described and shown above.

It is understood that the above are only a subset of what the efficient calibration for implicit feedback device 1519 may be configured to perform and that other functions included throughout this disclosure may also be performed by the efficient calibration for implicit feedback device 1519.

While the machine-readable medium 1522 is illustrated as a single medium, the term “machine-readable medium” may include a single medium or multiple media (e.g., a centralized or distributed database, and/or associated caches and servers) configured to store the one or more instructions 1524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1500 and that cause the machine 1500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1524 may further be transmitted or received over a communications network 1526 using a transmission medium via the network interface device/transceiver 1520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1520 may include one or more physical jacks (e.g., Ethernet, coaxial, or phone jacks) or one or more antennas to connect to the communications network 1526. In an example, the network interface device/transceiver 1520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

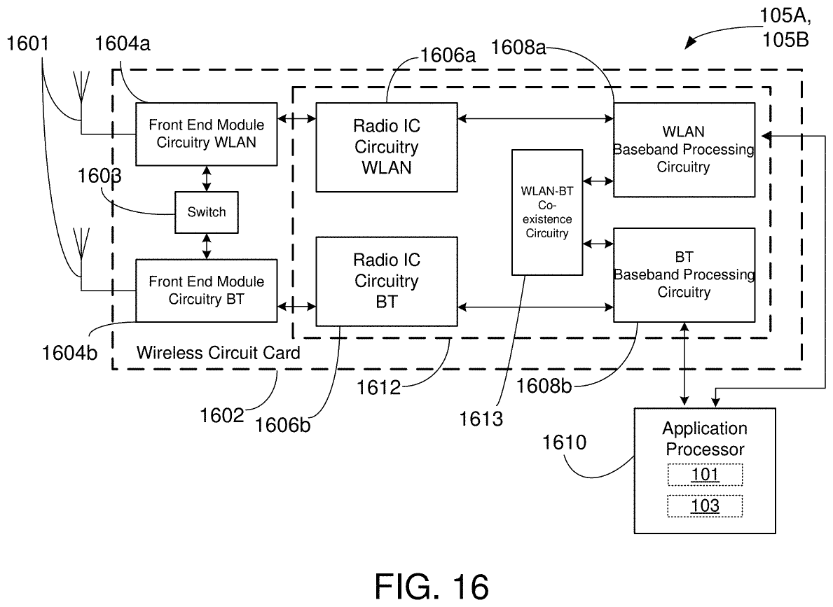

FIG. 16 is a block diagram of a radio architecture 105A, 105B in accordance with some embodiments that may be implemented in any one of the example AP 100 and/or the example STA 102 of FIG. 1. Radio architecture 105A, 105B may include radio front-end module (FEM) circuitry 1604a-b, radio IC circuitry 1606a-b and baseband processing circuitry 1608a-b. Radio architecture 105A, 105B as shown, includes both Wireless Local Area Network (WLAN) functionality and Bluetooth (BT) functionality although embodiments are not so limited. In this disclosure, “WLAN” and “Wi-Fi” are used interchangeably.

FEM circuitry 1604a-b may include a WLAN or Wi-Fi FEM circuitry 1604a and a Bluetooth (BT) FEM circuitry 1604b. The WLAN FEM circuitry 1604a may include a receive signal path comprising circuitry configured to operate on WLAN RF signals received from one or more antennas 1601, to amplify the received signals and to provide the amplified versions of the received signals to the WLAN radio IC circuitry 1606a for further processing. The BT FEM circuitry 1604b may include a receive signal path which may include circuitry configured to operate on BT RF signals received from one or more antennas 1601, to amplify the received signals and to provide the amplified versions of the received signals to the BT radio IC circuitry 1606b for further processing. FEM circuitry 1604a may also include a transmit signal path which may include circuitry configured to amplify WLAN signals provided by the radio IC circuitry 1606a for wireless transmission by one or more of the antennas 1601. In addition, FEM circuitry 1604b may also include a transmit signal path which may include circuitry configured to amplify BT signals provided by the radio IC circuitry 1606b for wireless transmission by the one or more antennas. In the embodiment of FIG. 16, although FEM 1604a and FEM 1604b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1606a-b as shown may include WLAN radio IC circuitry 1606a and BT radio IC circuitry 1606b. The WLAN radio IC circuitry 1606a may include a receive signal path which may include circuitry to down-convert WLAN RF signals received from the FEM circuitry 1604a and provide baseband signals to WLAN baseband processing circuitry 1608a. BT radio IC circuitry 1606b may in turn include a receive signal path which may include circuitry to down-convert BT RF signals received from the FEM circuitry 1604b and provide baseband signals to BT baseband processing circuitry 1608b. WLAN radio IC circuitry 1606a may also include a transmit signal path which may include circuitry to up-convert WLAN baseband signals provided by the WLAN baseband processing circuitry 1608a and provide WLAN RF output signals to the FEM circuitry 1604a for subsequent wireless transmission by the one or more antennas 1601. BT radio IC circuitry 1606b may also include a transmit signal path which may include circuitry to up-convert BT baseband signals provided by the BT baseband processing circuitry 1608b and provide BT RF output signals to the FEM circuitry 1604b for subsequent wireless transmission by the one or more antennas 1601. In the embodiment of FIG. 16, although radio IC circuitries 1606a and 1606b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1608a-b may include a WLAN baseband processing circuitry 1608a and a BT baseband processing circuitry 1608b. The WLAN baseband processing circuitry 1608a may include a memory, such as, for example, a set of RAM arrays in a Fast Fourier Transform or Inverse Fast Fourier Transform block (not shown) of the WLAN baseband processing circuitry 1608a. Each of the WLAN baseband circuitry 1608a and the BT baseband circuitry 1608b may further include one or more processors and control logic to process the signals received from the corresponding WLAN or BT receive signal path of the radio IC circuitry 1606a-b, and to also generate corresponding WLAN or BT baseband signals for the transmit signal path of the radio IC circuitry 1606a-b. Each of the baseband processing circuitries 1608a and 1608b may further include physical layer (PHY) and medium access control layer (MAC) circuitry, and may further interface with a device for generation and processing of the baseband signals and for controlling operations of the radio IC circuitry 1606a-b.

Referring still to FIG. 16, according to the shown embodiment, WLAN-BT coexistence circuitry 1613 may include logic providing an interface between the WLAN baseband circuitry 1608a and the BT baseband circuitry 1608b to enable use cases requiring WLAN and BT coexistence. In addition, a switch 1603 may be provided between the WLAN FEM circuitry 1604a and the BT FEM circuitry 1604b to allow switching between the WLAN and BT radios according to application needs. In addition, although the antennas 1601 are depicted as being respectively connected to the WLAN FEM circuitry 1604a and the BT FEM circuitry 1604b, embodiments include within their scope the sharing of one or more antennas as between the WLAN and BT FEMs, or the provision of more than one antenna connected to each of FEM 1604a or 1604b.

In some embodiments, the front-end module circuitry 1604a-b, the radio IC circuitry 1606a-b, and baseband processing circuitry 1608a-b may be provided on a single radio card, such as wireless radio card 1602. In some other embodiments, the one or more antennas 1601, the FEM circuitry 1604a-b and the radio IC circuitry 1606a-b may be provided on a single radio card. In some other embodiments, the radio IC circuitry 1606a-b and the baseband processing circuitry 1608a-b may be provided on a single chip or integrated circuit (IC), such as IC 1612.

In some embodiments, the wireless radio card 1602 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1608b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

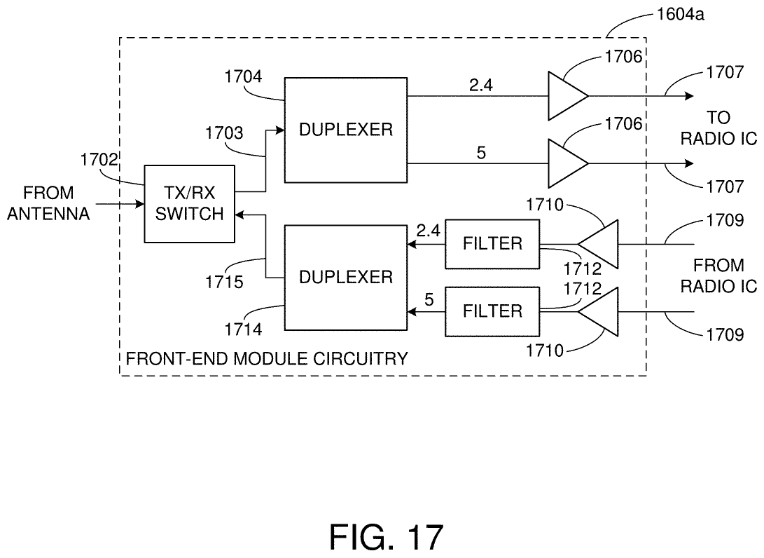

FIG. 17 illustrates WLAN FEM circuitry 1604a in accordance with some embodiments. Although the example of FIG. 17 is described in conjunction with the WLAN FEM circuitry 1604a, the example of FIG. 17 may be described in conjunction with the example BT FEM circuitry 1604b (FIG. 16), although other circuitry configurations may also be suitable.

In some embodiments, the FEM circuitry 1604a may include a TX/RX switch 1702 to switch between transmit mode and receive mode operation. The FEM circuitry 1604a may include a receive signal path and a transmit signal path. The receive signal path of the FEM circuitry 1604a may include a low-noise amplifier (LNA) 1706 to amplify received RF signals 1703 and provide the amplified received RF signals 1707 as an output (e.g., to the radio IC circuitry 1606a-b (FIG. 16)). The transmit signal path of the circuitry 1604a may include a power amplifier (PA) to amplify input RF signals 1709 (e.g., provided by the radio IC circuitry 1606a-b), and one or more filters 1712, such as band-pass filters (BPFs), low-pass filters (LPFs) or other types of filters, to generate RF signals 1715 for subsequent transmission (e.g., by one or more of the antennas 1601 (FIG. 16)) via an example duplexer 1714.

In some dual-mode embodiments for Wi-Fi communication, the FEM circuitry 1604a may be configured to operate in either the 2.4 GHz frequency spectrum or the 5 GHz frequency spectrum. In these embodiments, the receive signal path of the FEM circuitry 1604a may include a receive signal path duplexer 1704 to separate the signals from each spectrum as well as provide a separate LNA 1706 for each spectrum as shown. In these embodiments, the transmit signal path of the FEM circuitry 1604a may also include a power amplifier 1710 and a filter 1712, such as a BPF, an LPF or another type of filter for each frequency spectrum and a transmit signal path duplexer 1704 to provide the signals of one of the different spectrums onto a single transmit path for subsequent transmission by the one or more of the antennas 1601 (FIG. 16). In some embodiments, BT communications may utilize the 2.4 GHz signal paths and may utilize the same FEM circuitry 1604a as the one used for WLAN communications.

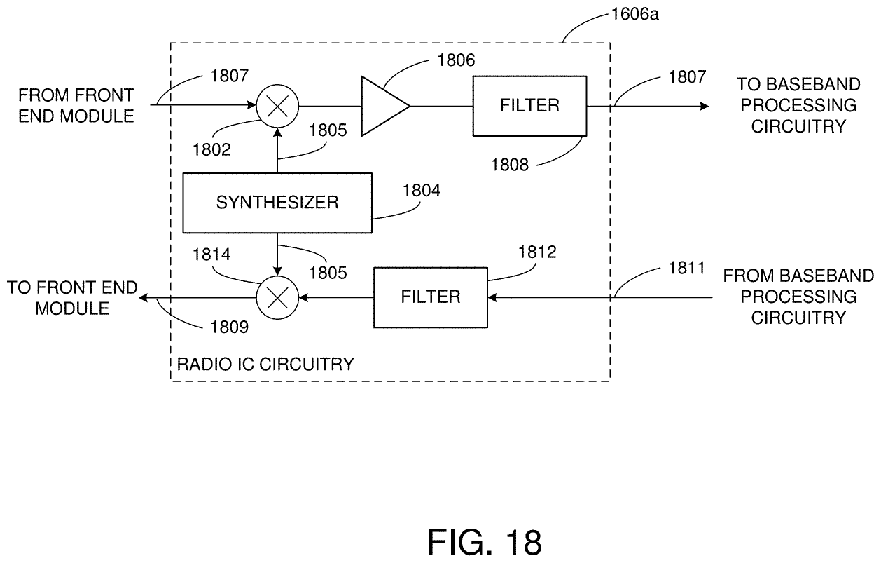

FIG. 18 illustrates radio IC circuitry 1606a in accordance with some embodiments. The radio IC circuitry 1606a is one example of circuitry that may be suitable for use as the WLAN or BT radio IC circuitry 1606a/1606b (FIG. 16), although other circuitry configurations may also be suitable. Alternatively, the example of FIG. 18 may be described in conjunction with the example BT radio IC circuitry 1606b.

In some embodiments, the radio IC circuitry 1606a may include a receive signal path and a transmit signal path. The receive signal path of the radio IC circuitry 1606a may include at least mixer circuitry 1802, such as, for example, down-conversion mixer circuitry, amplifier circuitry 1806 and filter circuitry 1808. The transmit signal path of the radio IC circuitry 1606a may include at least filter circuitry 1812 and mixer circuitry 1814, such as, for example, up-conversion mixer circuitry. Radio IC circuitry 1606a may also include synthesizer circuitry 1804 for synthesizing a frequency 1805 for use by the mixer circuitry 1802 and the mixer circuitry 1814. The mixer circuitry 1802 and/or 1814 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 18 illustrates only a simplified version of a radio IC circuitry, and may include, although not shown, embodiments where each of the depicted circuitries may include more than one component. For instance, mixer circuitry 1814 may each include one or more mixers, and filter circuitries 1808 and/or 1812 may each include one or more filters, such as one or more BPFs and/or LPFs according to application needs. For example, when mixer circuitries are of the direct-conversion type, they may each include two or more mixers.

In some embodiments, mixer circuitry 1802 may be configured to down-convert RF signals 1707 received from the FEM circuitry 1604a-b (FIG. 16) based on the synthesized frequency 1805 provided by synthesizer circuitry 1804. The amplifier circuitry 1806 may be configured to amplify the down-converted signals and the filter circuitry 1808 may include an LPF configured to remove unwanted signals from the down-converted signals to generate output baseband signals 1807. Output baseband signals 1807 may be provided to the baseband processing circuitry 1608a-b (FIG. 16) for further processing. In some embodiments, the output baseband signals 1807 may be zero-frequency baseband signals, although this is not a requirement. In some embodiments, mixer circuitry 1802 may comprise passive mixers, although the scope of the embodiments is not limited in this respect.

In some embodiments, the mixer circuitry 1814 may be configured to up-convert input baseband signals 1811 based on the synthesized frequency 1805 provided by the synthesizer circuitry 1804 to generate RF output signals 1709 for the FEM circuitry 1604a-b. The baseband signals 1811 may be provided by the baseband processing circuitry 1608a-b and may be filtered by filter circuitry 1812. The filter circuitry 1812 may include an LPF or a BPF, although the scope of the embodiments is not limited in this respect.

In some embodiments, the mixer circuitry 1802 and the mixer circuitry 1814 may each include two or more mixers and may be arranged for quadrature down-conversion and/or up-conversion respectively with the help of synthesizer 1804. In some embodiments, the mixer circuitry 1802 and the mixer circuitry 1814 may each include two or more mixers each configured for image rejection (e.g., Hartley image rejection). In some embodiments, the mixer circuitry 1802 and the mixer circuitry 1814 may be arranged for direct down-conversion and/or direct up-conversion, respectively. In some embodiments, the mixer circuitry 1802 and the mixer circuitry 1814 may be configured for super-heterodyne operation, although this is not a requirement.

Mixer circuitry 1802 may comprise, according to one embodiment: quadrature passive mixers (e.g., for the in-phase (I) and quadrature phase (Q) paths). In such an embodiment, RF input signal 1707 from FIG. 18 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1805 of synthesizer 1804 (FIG. 18). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1707 (FIG. 17) may comprise a balanced signal, although the scope of the embodiments is not limited in this respect. The I and Q baseband output signals may be provided to low-noise amplifier, such as amplifier circuitry 1806 (FIG. 18) or to filter circuitry 1808 (FIG. 18).

In some embodiments, the output baseband signals 1807 and the input baseband signals 1811 may be analog baseband signals, although the scope of the embodiments is not limited in this respect. In some alternate embodiments, the output baseband signals 1807 and the input baseband signals 1811 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1804 may be a fractional-N synthesizer or a fractional N/N+1 synthesizer, although the scope of the embodiments is not limited in this respect as other types of frequency synthesizers may be suitable. For example, synthesizer circuitry 1804 may be a delta-sigma synthesizer, a frequency multiplier, or a synthesizer comprising a phase-locked loop with a frequency divider. According to some embodiments, the synthesizer circuitry 1804 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1804 may be provided by a voltage controlled oscillator (VCO), although that is not a requirement. A divider control input may further be provided by either the baseband processing circuitry 1608a-b (FIG. 16) depending on the desired output frequency 1805. In some embodiments, a divider control input (e.g., N) may be determined from a look-up table (e.g., within a Wi-Fi card) based on a channel number and a channel center frequency as determined or indicated by the example application processor 1610. The application processor 1610 may include, or otherwise be connected to, one of the example secure signal converter 101 or the example received signal converter 103 (e.g., depending on which device the example radio architecture is implemented in).

In some embodiments, synthesizer circuitry 1804 may be configured to generate a carrier frequency as the output frequency 1805, while in other embodiments, the output frequency 1805 may be a fraction of the carrier frequency (e.g., one-half the carrier frequency, one-third the carrier frequency). In some embodiments, the output frequency 1805 may be a LO frequency (fLO).

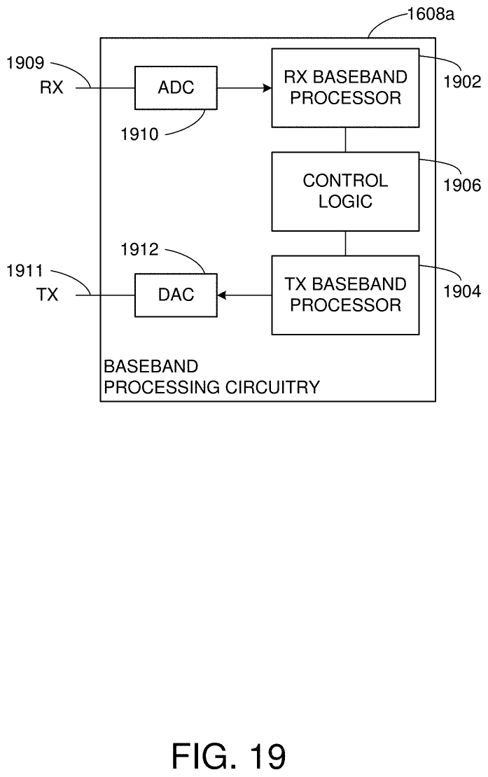

FIG. 19 illustrates a functional block diagram of baseband processing circuitry 1608a in accordance with some embodiments. The baseband processing circuitry 1608a is one example of circuitry that may be suitable for use as the baseband processing circuitry 1608a (FIG. 16), although other circuitry configurations may also be suitable. Alternatively, the example of FIG. 18 may be used to implement the example BT baseband processing circuitry 1608b of FIG. 16.

The baseband processing circuitry 1608a may include a receive baseband processor (RX BBP) 1902 for processing receive baseband signals 1809 provided by the radio IC circuitry 1606a-b (FIG. 16) and a transmit baseband processor (TX BBP) 1904 for generating transmit baseband signals 1811 for the radio IC circuitry 1606a-b. The baseband processing circuitry 1608a may also include control logic 1906 for coordinating the operations of the baseband processing circuitry 1608a.

In some embodiments (e.g., when analog baseband signals are exchanged between the baseband processing circuitry 1608a-b and the radio IC circuitry 1606a-b), the baseband processing circuitry 1608a may include ADC 1910 to convert analog baseband signals 1909 received from the radio IC circuitry 1606a-b to digital baseband signals for processing by the RX BBP 1902. In these embodiments, the baseband processing circuitry 1608a may also include DAC 1912 to convert digital baseband signals from the TX BBP 1904 to analog baseband signals 1911.

In some embodiments that communicate OFDM signals or OFDMA signals, such as through baseband processor 1608a, the transmit baseband processor 1904 may be configured to generate OFDM or OFDMA signals as appropriate for transmission by performing an inverse fast Fourier transform (IFFT). The receive baseband processor 1902 may be configured to process received OFDM signals or OFDMA signals by performing an FFT. In some embodiments, the receive baseband processor 1902 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 16, in some embodiments, the antennas 1601 (FIG. 16) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1601 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: cause to send a first sounding frame to a first station device, wherein the first sounding frame may be used for a calibration of a plurality of (TX) antennas and a plurality of (RX) antennas; identify one or more quantization indices received from the first station device, wherein the one or more quantization indices are associated with a quantization of a feedback vector, wherein the quantization of the feedback vector may be performed by jointly quantizing first channel estimates from an RX antenna at the first station device and each of the plurality of TX antennas at the device; reconstruct the feedback vector using the one or more quantization indices; identify a second sounding frame from the first station device; determine second channel estimates based on the RX antenna at the first station device and the plurality of TX antennas at the device; compare the reconstructed feedback vector with the second channel estimates; and determine a compensation scalar based on the comparison.

Example 2 may include the device of example 1 and/or some other example herein, wherein the compensation scalar may be used to compensate for a difference between a transmit chain and a corresponding receive chain connected to a same TX antenna at the device.3. Example 3 may include the device of example 2 and/or some other example herein, wherein the processing circuitry may be further configured to determine that ratios of a transmit chain response to a corresponding receive chain response remains the same for the plurality of TX antennas.

Example 4 may include the device of example 1 and/or some other example herein, wherein the calibration may be initiated by sending a null data packet announcement (NDPA) frame or a trigger frame.

Example 5 may include the device of example 1 and/or some other example herein, wherein the processing circuitry may be further configured to send one or more data frames on the plurality of the TX antennas by applying the compensation scalar to the one or more data frames.

Example 6 may include the device of example 1 and/or some other example herein, wherein the second sounding frame may be a null data packet (NDP) frame received from the first station device.

Example 7 may include the device of example 1 and/or some other example herein, wherein the second sounding frame may be a calibration feedback frame or any frame with data comprising one or more long training fields (LTFs).

Example 8 may include the device of example 7 and/or some other example herein, wherein the one or more LTFs are used for channel estimation.

Example 9 may include a non-transitory computer-readable medium storing computer-executable instructions which when executed by one or more processors result in performing operations comprising: cause to send a first sounding frame to a first station device, wherein the first sounding frame may be used for a calibration of a plurality of (TX) antennas and a plurality of (RX) antennas; identify one or more quantization indices received from the first station device, wherein the one or more quantization indices are associated with a quantization of a feedback vector, wherein the quantization of the feedback vector may be performed by jointly quantizing first channel estimates from an RX antenna at the first station device and each of the plurality of TX antennas at the device; reconstructing the feedback vector using the one or more quantization indices; identify a second sounding frame from the first station device; determine second channel estimates based on the RX antenna at the first station device and the plurality of TX antennas at the device; compare the reconstructed feedback vector with the second channel estimates; and determine a compensation scalar based on the comparison.

Example 10 may include the non-transitory computer-readable medium of example 9 and/or some other example herein, wherein the compensation scalar may be used to compensate for a difference between a transmit chain and a corresponding receive chain connected to a same TX antenna at the device.

Example 11 may include the non-transitory computer-readable medium of example 10 and/or some other example herein, wherein the operations further comprise determine that ratios of a transmit chain response to a corresponding receive chain response remains the same for the plurality of TX antennas.

Example 12 may include the non-transitory computer-readable medium of example 9 and/or some other example herein, wherein the calibration may be initiated by sending a null data packet announcement (NDPA) frame or a trigger frame.

Example 13 may include the non-transitory computer-readable medium of example 9 and/or some other example herein, wherein the operations further comprise send one or more data frames on the plurality of the TX antennas by applying the compensation scalar to the one or more data frames.

Example 14 may include the non-transitory computer-readable medium of example 9 and/or some other example herein, wherein the second sounding frame may be a null data packet (NDP) frame received from the first station device.

Example 15 may include the non-transitory computer-readable medium of example 9 and/or some other example herein, wherein the second sounding frame may be a calibration feedback frame or any frame with data comprising one or more long training fields (LTFs).

Example 16 may include the non-transitory computer-readable medium of example 15 and/or some other example herein, wherein the one or more LTFs are used for channel estimation.

Example 17 may include a method comprising: cause to send a first sounding frame to a first station device, wherein the first sounding frame may be used for a calibration of a plurality of (TX) antennas and a plurality of (RX) antennas; identify one or more quantization indices received from the first station device, wherein the one or more quantization indices are associated with a quantization of a feedback vector, wherein the quantization of the feedback vector may be performed by jointly quantizing first channel estimates from an RX antenna at the first station device and each of the plurality of TX antennas at the device; reconstructing the feedback vector using the one or more quantization indices; identify a second sounding frame from the first station device; determine second channel estimates based on the RX antenna at the first station device and the plurality of TX antennas at the device; compare the reconstructed feedback vector with the second channel estimates; and determine a compensation scalar based on the comparison.

Example 18 may include the method of example 17 and/or some other example herein, wherein the compensation scalar may be used to compensate for a difference between a transmit chain and a corresponding receive chain connected to a same TX antenna at the device.

Example 19 may include the method of example 18 and/or some other example herein, further comprising determine that ratios of a transmit chain response to a corresponding receive chain response remains the same for the plurality of TX antennas.

Example 20 may include the method of example 17 and/or some other example herein, wherein the calibration may be initiated by sending a null data packet announcement (NDPA) frame or a trigger frame.

Example 21 may include the method of example 17 and/or some other example herein, further comprising send one or more data frames on the plurality of the TX antennas by applying the compensation scalar to the one or more data frames.

Example 22 may include the method of example 17 and/or some other example herein, wherein the second sounding frame may be a null data packet (NDP) frame received from the first station device.

Example 23 may include the method of example 17 and/or some other example herein, wherein the second sounding frame may be a calibration feedback frame or any frame with data comprising one or more long training fields (LTFs).

Example 24 may include the method of example 23 and/or some other example herein, wherein the one or more LTFs are used for channel estimation.

Example 25 may include an apparatus comprising means for: cause to send a first sounding frame to a first station device, wherein the first sounding frame may be used for a calibration of a plurality of (TX) antennas and a plurality of (RX) antennas; identify one or more quantization indices received from the first station device, wherein the one or more quantization indices are associated with a quantization of a feedback vector, wherein the quantization of the feedback vector may be performed by jointly quantizing first channel estimates from an RX antenna at the first station device and each of the plurality of TX antennas at the device; reconstructing the feedback vector using the one or more quantization indices; identify a second sounding frame from the first station device; determine second channel estimates based on the RX antenna at the first station device and the plurality of TX antennas at the device; compare the reconstructed feedback vector with the second channel estimates; and determine a compensation scalar based on the comparison.

Example 26 may include the apparatus of example 1 and/or some other example herein, wherein the compensation scalar may be used to compensate for a difference between a transmit chain and a corresponding receive chain connected to a same TX antenna at the device.

Example 27 may include the apparatus of example 26 and/or some other example herein, further comprising determine that ratios of a transmit chain response to a corresponding receive chain response remains the same for the plurality of TX antennas.

Example 28 may include the apparatus of example 1 and/or some other example herein, wherein the calibration may be initiated by sending a null data packet announcement (NDPA) frame or a trigger frame.

Example 29 may include the apparatus of example 1 and/or some other example herein, further comprising send one or more data frames on the plurality of the TX antennas by applying the compensation scalar to the one or more data frames.

Example 30 may include the apparatus of example 1 and/or some other example herein, wherein the second sounding frame may be a null data packet (NDP) frame received from the first station device.

Example 31 may include the apparatus of example 1 and/or some other example herein, wherein the second sounding frame may be a calibration feedback frame or any frame with data comprising one or more long training fields (LTFs).

Example 32 may include the apparatus of example 31 and/or some other example herein, wherein the one or more LTFs are used for channel estimation.

Example 33 may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Example 34 may include an apparatus comprising logic, modules, and/or circuitry to perform one or more elements of a method described in or related to any of examples 1-32, or any other method or process described herein.

Example 35 may include a method, technique, or process as described in or related to any of examples 1-32, or portions or parts thereof.

Example 36 may include an apparatus comprising: one or more processors and one or more computer readable media comprising instructions that, when executed by the one or more processors, cause the one or more processors to perform the method, techniques, or process as described in or related to any of examples 1-32, or portions thereof.

Example 37 may include a method of communicating in a wireless network as shown and described herein.

Example 38 may include a system for providing wireless communication as shown and described herein.

Example 39 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
cause to send a first sounding frame to a first station device, wherein the first sounding frame is used for a calibration of a plurality of (TX) antennas and a plurality of (RX) antennas;
identify one or more quantization indices received from the first station device, wherein the one or more quantization indices are associated with a quantization of a feedback vector, wherein the quantization of the feedback vector is performed by jointly quantizing first channel estimates from an RX antenna at the first station device and each of the plurality of TX antennas at the device;
reconstruct the feedback vector using the one or more quantization indices;
identify a second sounding frame from the first station device;
determine second channel estimates based on the RX antenna at the first station device and the plurality of TX antennas at the device;
compare the reconstructed feedback vector with the second channel estimates; and
determine a compensation scalar based on the comparison.

2. The device of claim 1, wherein the compensation scalar is used to compensate for a difference between a transmit chain and a corresponding receive chain connected to a same TX antenna at the device.

3. The device of claim 2, wherein the processing circuitry is further configured to determine that ratios of a transmit chain response to a corresponding receive chain response remains the same for the plurality of TX antennas.

4. The device of claim 1, wherein the calibration is initiated by sending a null data packet announcement (NDPA) frame or a trigger frame.

5. The device of claim 1, wherein the processing circuitry is further configured to send one or more data frames on the plurality of the TX antennas by applying the compensation scalar to the one or more data frames.

6. The device of claim 1, wherein the second sounding frame is a null data packet (NDP) frame received from the first station device.

7. The device of claim 1, wherein the second sounding frame is a calibration feedback frame or any frame with data comprising one or more long training fields (LTFs).

8. The device of claim 7, wherein the one or more LTFs are used for channel estimation.

9. A non-transitory computer-readable medium storing computer-executable instructions which when executed by one or more processors result in performing operations comprising:
causing to send a first sounding frame to a first station device, wherein the first sounding frame is used for a calibration of a plurality of (TX) antennas and a plurality of (RX) antennas;
identifying one or more quantization indices received from the first station device, wherein the one or more quantization indices are associated with a quantization of a feedback vector, wherein the quantization of the feedback vector is performed by jointly quantizing first channel estimates from an RX antenna at the first station device and each of the plurality of TX antennas at the device;
reconstructing the feedback vector using the one or more quantization indices;
identifying a second sounding frame from the first station device;
determining second channel estimates based on the RX antenna at the first station device and the plurality of TX antennas at the device;
comparing the reconstructed feedback vector with the second channel estimates; and
determining a compensation scalar based on the comparison.

10. The non-transitory computer-readable medium of claim 9, wherein the compensation scalar is used to compensate for a difference between a transmit chain and a corresponding receive chain connected to a same TX antenna at the device.

11. The non-transitory computer-readable medium of claim 10, wherein the operations further comprise determining that ratios of a transmit chain response to a corresponding receive chain response remains the same for the plurality of TX antennas.

12. The non-transitory computer-readable medium of claim 9, wherein the calibration is initiated by sending a null data packet announcement (NDPA) frame or a trigger frame.

13. The non-transitory computer-readable medium of claim 9, wherein the operations further comprise send one or more data frames on the plurality of the TX antennas by applying the compensation scalar to the one or more data frames.

14. The non-transitory computer-readable medium of claim 9, wherein the second sounding frame is a null data packet (NDP) frame received from the first station device.

15. The non-transitory computer-readable medium of claim 9, wherein the second sounding frame is a calibration feedback frame or any frame with data comprising one or more long training fields (LTFs).

16. The non-transitory computer-readable medium of claim 15, wherein the one or more LTFs are used for channel estimation.

17. A method comprising:
causing to send a first sounding frame to a first station device, wherein the first sounding frame is used for a calibration of a plurality of (TX) antennas and a plurality of (RX) antennas;
identifying one or more quantization indices received from the first station device, wherein the one or more quantization indices are associated with a quantization of a feedback vector, wherein the quantization of the feedback vector is performed by jointly quantizing first channel estimates from an RX antenna at the first station device and each of the plurality of TX antennas at the device;
reconstructing the feedback vector using the one or more quantization indices;
identifying a second sounding frame from the first station device;
determining second channel estimates based on the RX antenna at the first station device and the plurality of TX antennas at the device;
comparing the reconstructed feedback vector with the second channel estimates; and
determining a compensation scalar based on the comparison.

18. The method of claim 17, wherein the compensation scalar is used to compensate for a difference between a transmit chain and a corresponding receive chain connected to a same TX antenna at the device.

19. The method of claim 18, further comprising determining that ratios of a transmit chain response to a corresponding receive chain response remains the same for the plurality of TX antennas.

20. The method of claim 17, wherein the calibration is initiated by sending a null data packet announcement (NDPA) frame or a trigger frame.
